(19) United States
(12) Patent Application Publication
(10) Pub. No.: US 2025/0343889 A1
(43) Pub. Date: Nov. 6, 2025

(54) INFORMATION PROCESSING APPARATUS AND INFORMATION PROCESSING METHOD

(71) Applicant: Maxell, Ltd., Kyoto (JP)

(72) Inventors: Hiroshi NAKAMORI, Kyoto (JP); Yasunobu HASHIMOTO, Kyoto (JP); Kazuyuki TAKIZAWA, Kyoto (JP); Yoshinori OKADA, Kyoto (JP)

(21) Appl. No.: 18/869,905

(22) PCT Filed: May 30, 2022
(86) PCT No.: PCT/JP2022/022006

§ 371 Date: Nov. 27, 2024

(51) Int. Cl. H04N 13/383; H04N 13/117; H04N 13/122; H04N 13/189; H04N 13/398

(52) U.S. Cl. CPC H04N 13/383; H04N 13/117; H04N 13/122; H04N 13/189; H04N 13/398

(57) ABSTRACT

In an information processing apparatus that is worn by a user and is used and an information processing method, a stereoscopic video virtual object is played back, the played video virtual object is disposed and displayed to be superimposed on a real object, and user information including at least one of a disposition position where the video virtual object is disposed, a position of the user, and a direction of a line of sight of the user is recorded. When it is detected that the user has moved out of a range that is a predetermined distance away from the disposition position, the playback of the video virtual object is stopped. When the user enters the range after the playback of the video virtual object is stopped, the playback of the video virtual object is resumed on the basis of the recorded user information.

### TECHNICAL FIELD

The present invention relates to an information processing apparatus and an information processing method.

### BACKGROUND ART

In recent years, an augmented reality (AR) technology which gives digital information to a real world and reflects a virtual object in a virtual space created by computer graphics (CG) and like in a real space to augment the virtual object has been widely used. Information processing apparatus that can easily handle virtual objects while recognizing the real space in three dimensions have come into widespread use as apparatus using this technology. An example of the information processing apparatus is a head mounted display (HMD) that is mounted on the head and has a display, a camera, and the like.

Patent Document 1 describes the following as a method for pausing or playing back a motion of a video of a virtual object (hereinafter, sometimes referred to as a video virtual object). That is, Patent Document 1 discloses the following: “A playback unit 107 plays back video data stored in a storage unit 104 (301). In parallel with a playback process by the playback unit 107, a mixed reality processing unit 103 acquires a position of a point of view of a user (or a position of the user) and a direction of a line of sight of the user using position and posture estimation results by a own-position attitude estimating unit 106 and an eye tracking function (S302). The mixed reality processing unit 103 calculates the deviation Φ of the line of sight from a video playback screen G and a distance D between the self-position of the user and the video playback screen G. The playback unit 107 adjusts a playback speed according to the deviation Φ and the distance D (S303). For example, in a case where the deviation Φ is a predetermined angle and the distance D is equal to or greater than a predetermined value, the playback unit 107 slows down the playback speed or stops the playback. In addition, at least one of conditions for the deviation Φ and the distance D may be satisfied. This is a criterion for determining whether or not the user is viewing the video playback screen G”.

Further, Patent Document 2 discloses the following: “A user terminal 1500 has a function of acquiring measurement data obtained by measuring the position and posture of the user terminal 1500, disposes an object and a virtual camera in a virtual three-dimensional space, and controls the position and posture of the virtual camera in operative association with the measurement data. Then, the user terminal 1500 records camerawork data 550 that can reproduce the position and posture of the virtual camera, while generating a virtual space image captured by the virtual camera and displaying the virtual space image as a monitor image.”; and “A playback image generation control unit 232 performs control to generate a playback image, which is an image of the virtual three-dimensional space from the virtual camera at a given playback timing of the camerawork, on the basis of the camerawork data 550 recorded by a recording control unit 224”.

### CITATION LIST

### Patent Document

Patent Document 1: International Publication No. WO 2021/132168 A1
Patent Document 2: JP 2020-119334 A

### SUMMARY OF THE INVENTION

### Problems to be Solved by the Invention

As described above, Patent Document 1 discloses that the stop and playback of the video virtual object screen are controlled on the basis of the deviation of the position and direction of the line of sight of the user from the disposed planar video virtual object and the distance. However, the case of a stereoscopic video virtual object that can be viewed from a plurality of positions or directions is not considered at all. Therefore, there is a problem in stopping or resuming the viewing of the stereoscopic video virtual object in an appropriate state or at an appropriate timing.

As described above, Patent Document 2 discloses that the playback of the video virtual object is controlled on the basis of information related to the camerawork (the position and posture of the camera). However, there is no suggestion for the line of sight of the user to the video virtual object or the distance from the user. Therefore, there is a problem in that it is not possible to control the stop and playback of the video virtual object on the basis of the deviation of the position and direction of the line of sight of the user from the video virtual object and the distance from the user. In addition, Patent Document 2 discloses a technique for suitable “video creation”, but does not disclose any description of suitable “viewing”. Patent Document 2 has a problem with stopping or resuming “viewing” at an appropriate timing.

Accordingly, the present invention has been made in view of the above problems, and an object of the present invention is to provide an information processing apparatus and an information processing method that enable a user to simply and conveniently stop or resume viewing when the user views a stereoscopic video virtual object.

### Solutions to Problems

An outline of representative inventions among the inventions disclosed in this application will be described as follows.

(1) There is provided an information processing apparatus worn by a user. The information processing apparatus includes a processor controlling playback of a stereoscopic video virtual object, a positioning sensor detecting a position of the user, a gaze sensor detecting a direction of a line of sight of the user, and a memory. The processor records, in the memory, user information including at least one of a disposition position where the played video virtual object is disposed, the position of the user detected by the positioning sensor, and the direction of the line of sight of the user detected by the gaze sensor. In addition, the processor performs control to stop the playback of the video virtual object when detecting that the user has moved out of a range that is a predetermined distance away from the disposition position using the positioning sensor and performs control to resume the playback of the video virtual object on the basis of the user information recorded in the memory and the position detected by the positioning sensor or the direction of the line of sight detected by the gaze sensor when the user enters the range after the playback of the video virtual object is stopped.

(2) In the information processing apparatus according to (1), in a case where the user enters the range after the playback of the video virtual object is stopped, when the position detected by the positioning sensor and the direction of the line of sight detected by the gaze sensor correspond to the user information recorded in the memory, the processor resumes the playback of the video virtual object.

(3) In the information processing apparatus according to (1), in a case where the user enters the range after the playback of the video virtual object is stopped, when the position detected by the positioning sensor or the direction of the line of sight detected by the gaze sensor is different from the user information recorded in the memory, the processor performs control to notify the user of the difference.

(4) In the information processing apparatus according to (1), the processor records a range of the video virtual object in the direction of the line of sight as a gaze range in the memory in a case where an amount of change in the direction of the line of sight of the user detected by the gaze sensor is equal to or less than a threshold value for a predetermined period of time and resumes the playback of the video virtual object when the user enters the range after the playback of the video virtual object is stopped and the direction of the line of sight of the user enters the gaze range.

(5) In the information processing apparatus according to (1), the processor records a position and direction suitable for viewing the video virtual object as suitable disposition information in the memory and notifies the user of the suitable disposition information recorded in the memory when the user enters the range after the playback of the video virtual object is stopped.

(6) The information processing apparatus according to (1) further includes a display displaying the video virtual object played back by the processor. When the user enters the range after the playback of the video virtual object is stopped and the position detected by the positioning sensor or the direction of the line of sight detected by the gaze sensor is different from the user information recorded in the memory, the processor performs control to rotate the video virtual object and to display the video virtual object on the display.

(7) The information processing apparatus according to (1) further includes a display. The processor performs control to display the video virtual object on the display to be superimposed on a real object and performs control to rotate the video virtual object according to a shape or size of the real object and to display the video virtual object on the display when the user enters the range after the playback of the video virtual object is stopped and the position detected by the positioning sensor or the direction of the line of sight detected by the gaze sensor is different from the user information recorded in the memory.

(8) In the information processing apparatus according to (1), when the user enters the range after the playback of the video virtual object is stopped, the processor performs control to resume the playback of the video virtual object at a position that is a predetermined time before a position where the playback of the video virtual object was stopped.

(9) In the information processing apparatus according to (1), the processor records a plurality of playback positions as a position where the video virtual object is played back in the memory, notifies the user of the plurality of playback positions when the user enters the range after the playback of the video virtual object is stopped, and performs control to resume the playback of the video virtual object from a playback position selected by the user.

(10) In the information processing apparatus according to (1), the processor notifies the user whether or not to resume the playback of the video virtual object when the user does not enter the range even after a predetermined time has elapsed since the playback of the video virtual object was stopped and performs control to dispose the video virtual object, whose playback has been resumed, at a position different from the disposition position recorded in the memory when the user selects to resume the playback.

(11) There is provided an information processing apparatus that has a function of generating a stereoscopic video virtual object and displaying the stereoscopic video virtual object and is worn by a user. The information processing apparatus includes a processor and a storage. The processor records mutual disposition information, which is a mutual position and direction relationship between the video virtual object and a position and a line of sight of the user, in the storage, stops playback of the video virtual object when the user moves away from the video virtual object and a distance between the video virtual object and the user is equal to or greater than a predetermined distance, disposes the video virtual object so as to follow a movement of the information processing apparatus in a state based on the mutual disposition information recorded in the storage after a predetermined time has elapsed since the stop, and controls a playback operation of the disposed video virtual object.

(12) In the information processing apparatus according to (11), the processor notifies the user whether or not to play back a motion of the disposed video virtual object, and performs the playback operation of the disposed video virtual object when the user who has received the notification selects to play back the motion of the disposed video virtual object.

(13) In the information processing apparatus according to (11), when discerning that a size of the video virtual object is larger than a predetermined threshold value, the processor reduces the size of the video virtual object and disposes the video virtual object.

(14) In the information processing apparatus according to (11), the processor records a gaze location of the user on the video virtual object before the stop in the storage and disposes the video virtual object obtained by extracting a range of a predetermined region including the gaze location recorded in the storage when discerning that a size of the video virtual object is larger than a predetermined threshold value.

(15) There is provided an information processing method in an apparatus that is worn by a user and is used. The information processing method includes: playing back a stereoscopic video virtual object; disposing and displaying the played video virtual object to be superimposed on a real object; recording user information including at least one of a disposition position where the played video virtual object is disposed, a position of the user, and a direction of a line of sight of the user; stopping the playback of the video virtual object when it is detected that the user has moved out of a range that is a predetermined distance away from the disposition position; and resuming the playback of the video virtual object on the basis of the recorded user information when the user enters the range after the playback of the video virtual object is stopped.

### Effects of the Invention

When the technology of the present invention is used, the effect of achieving an information processing apparatus and an information processing method that enable a user to simply and conveniently stop or resume viewing when the user views a stereoscopic video virtual object.

In addition, problems, configurations, and effects other than the above will become apparent from the following description of embodiments.

### BRIEF DESCRIPTION OF THE DRAWINGS

FIG. 1 is an example of a diagram schematically illustrating an appearance of an example of an information processing apparatus according to this embodiment.

FIG. 2 is an example of a diagram schematically illustrating an appearance of a specific display screen according to the embodiment illustrated in FIG. 1.

FIG. 3 is an example of a diagram illustrating a control operation of the information processing apparatus according to this embodiment illustrated in FIG. 1.

FIG. 4(a) is another example of the diagram illustrating the control operation of the information processing apparatus according to this embodiment illustrated in FIG. 1.

FIG. 4(b) is an example of a diagram schematically illustrating an appearance of a display screen at the time of the control operation of the information processing apparatus according to this embodiment illustrated in FIG. 4(a).

FIG. 5(a) is another example of the diagram illustrating the control operation of the information processing apparatus according to this embodiment illustrated in FIG. 1.

FIG. 5(b) is another example of the diagram illustrating the control operation of the information processing apparatus according to this embodiment illustrated in FIG. 1.

FIG. 6 is an example of a flowchart illustrating a basic operation of the information processing apparatus according to this embodiment.

FIG. 7 is an example of a diagram illustrating a recording operation of the information processing apparatus according to this embodiment illustrated in FIG. 1.

FIG. 8 is another example of the diagram illustrating the control operation of the information processing apparatus according to this embodiment illustrated in FIG. 1.

FIG. 9 is another example of the diagram illustrating the control operation of the information processing apparatus according to this embodiment illustrated in FIG. 1.

FIG. 10(a) is another example of the diagram illustrating the control operation of the information processing apparatus according to this embodiment illustrated in FIG. 1.

FIG. 10(b) is an example of a diagram illustrating results of the control operation of the information processing apparatus according to this embodiment illustrated in FIG. 10(a).

FIG. 11 is another example of the diagram illustrating the control operation of the information processing apparatus according to this embodiment illustrated in FIG. 1.

FIG. 12 is another example of the diagram illustrating the control operation of the information processing apparatus according to this embodiment illustrated in FIG. 1.

FIG. 13 is another example of the diagram illustrating the control operation of the information processing apparatus according to this embodiment illustrated in FIG. 1.

FIG. 14 is another example of the diagram illustrating the control operation of the information processing apparatus according to this embodiment illustrated in FIG. 1.

FIG. 15(a) is another example of the diagram illustrating the control operation of the information processing apparatus according to this embodiment illustrated in FIG. 1.

FIG. 15(b) is another example of the diagram illustrating the control operation of the information processing apparatus according to this embodiment illustrated in FIG. 1.

FIG. 15(c) is another example of the diagram illustrating the control operation of the information processing apparatus according to this embodiment illustrated in FIG. 1.

FIG. 15(d) is another example of the diagram illustrating the control operation of the information processing apparatus according to this embodiment illustrated in FIG. 1.

FIG. 15(e) is another example of the diagram illustrating the control operation of the information processing apparatus according to this embodiment illustrated in FIG. 1.

FIG. 15(f) is another example of the diagram illustrating the control operation of the information processing apparatus according to this embodiment illustrated in FIG. 1.

FIG. 16 is a block diagram illustrating an example of a configuration of an HMD as an example of the information processing apparatus according to this embodiment.

### MODE FOR CARRYING OUT THE INVENTION

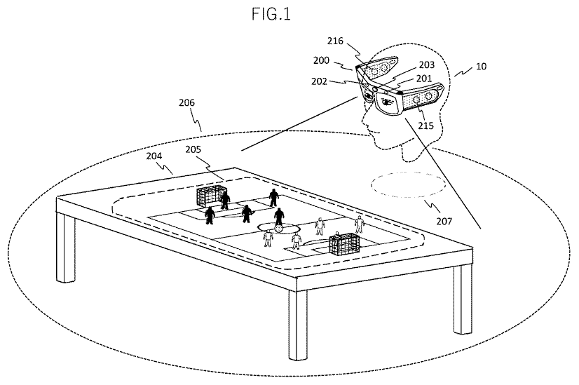

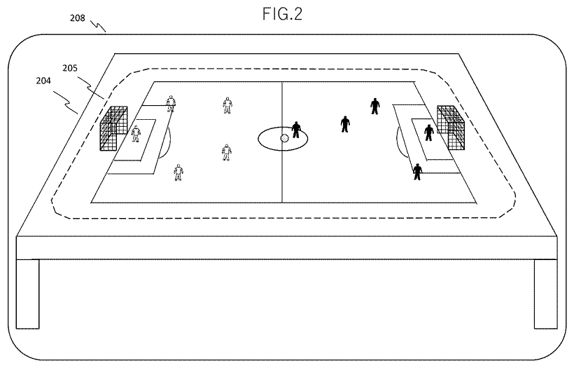

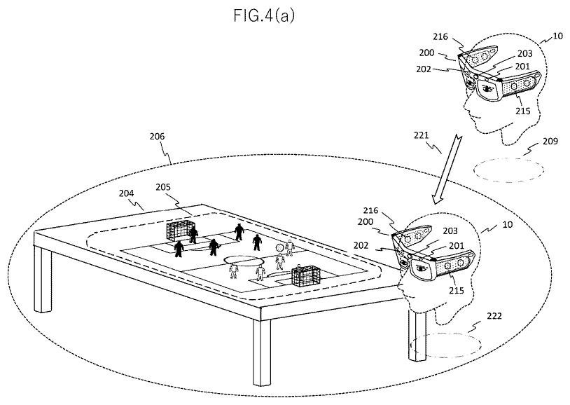

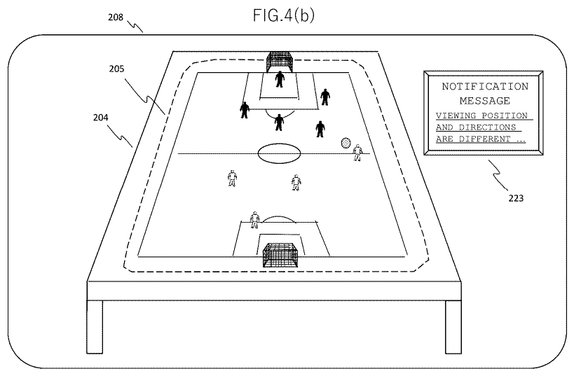

Hereinafter, an example of an embodiment of the present invention will be described with reference to the drawings. A head mounted display (HMD) that is mounted on a head of a user and displays information of a real space and a virtual space such that the user views the information will be described as a specific example of an information processing apparatus according to this embodiment. FIGS. 1, 3, 4(a), 5(a), 5(b), and 7 are examples of a diagram schematically illustrating the appearance of the information processing apparatus according to this embodiment, and FIGS. 2 and 4(b) are examples of a diagram illustrating a display screen within a range of a field of view of the information processing apparatus according to this embodiment. In FIG. 1, an HMD 200 is mounted on a head of a user 10. The HMD 200 includes a left eye gaze sensor 201 and a right eye gaze sensor 202 that detect the lines of sight of the left and right eyes of the user 10, a camera 203 that images the outside world, a positioning sensor 215 that detects a position on the earth, and a geomagnetic sensor 216 that detects a direction in which the HMD is facing.

In contrast to an optical see-through HMD that allows the user 10 to directly view a real object within the surrounding field of view in front of the user, a video see-through HMD images a real object within the surrounding field of view in front of the user using the camera 203 and displays the captured image of the real object on a display. The HMD 200 generates a stereoscopic video virtual object in addition to the real object and three-dimensionally disposes and displays the objects within the field of view of the user 10. This enables the user 10 to view the video virtual object as if the virtual object is actually present at that location in the real world.

In addition, the HMD 200 records information related to the position or direction of the disposed stereoscopic video virtual object. FIG. 1 illustrates a case where a video virtual object 205, which is a video of a soccer game, is disposed in a space on a desk 204 which is a real object. Further, it is preferable to display a selection screen for the user 10 to select the real object on which the video virtual object is to be disposed such that the user 10 can dispose the video virtual object at any location, which is not illustrated. Furthermore, the HMD 200 detects the position of the user 10 using the positioning sensor 215 provided therein and detects the direction in which the user 10 is facing using the geomagnetic sensor 216 provided therein.

When the user 10 is located at a position 207 in a control area range 206 that is within a predetermined distance from the video virtual object 205 as illustrated in FIG. 1, the user 10 can view the video virtual object 205. That is, as illustrated in FIG. 2, the user 10 can view the video of the soccer game, which is an example of the video virtual object 205 disposed on the desk 204, on a display screen 208 within the range of the field of view. In addition, the desk 204 may be a virtual object different from the video virtual object 205. At this time, that is, when the video virtual object 205 is displayed, the HMD 200 can grasp the position and direction of the video virtual object 205 disposed in the three-dimensional space. Further, the HMD 200 can detect the position and direction of the user 10 using the positioning sensor 215 and the geomagnetic sensor 216 and can detect the line of sight of the user 10 using the left eye gaze sensor 201 and the right eye gaze sensor 202. Therefore, the HMD 200 can specify the relationship between the video virtual object 205 and the position and direction of the user 10 and the relationship between the direction in which the video virtual object 205 is displayed and the direction of the line of sight of the user 10 and acquire the specified relationships.

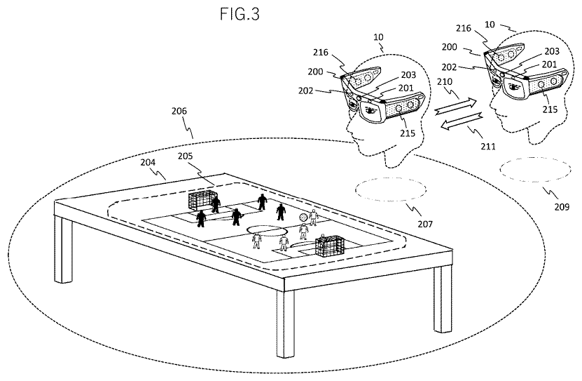

Here, the user 10 moves to a position 209 that is a predetermined distance away from the video virtual object 205 and is outside the control area range 206, as represented by an arrow 210 in FIG. 3. In this case, the HMD 200 pauses the motion of the video virtual object 205 which is the video of the soccer game in progress. This enables the user 10 to immediately pause the motion of the video virtual object only by moving out of the control area range 206, without requiring any special operation by the user. In addition, the HMD 200 specifies the relationship between the video virtual object 205 and the position and direction of the user 10 and the relationship between the direction in which the video virtual object 205 is displayed and the direction of the line of sight of the user 10 and records the mutual position and direction relationship before the pause as mutual disposition information.

Here, the HMD 200 records information which will be described below as the mutual disposition information. For example, the HMD 200 records a relative position and direction relationship with respect to the video virtual object 205 at a stay position where the user 10 stayed before leaving the control area range 206 (a movement start position when the user 10 moved out of the control area range 206). In addition, in a case where the user 10 moves out of the control area range 206 without facing the direction of the video virtual object 205 for a predetermined period of time, the HMD 200 records information which will be described below as the mutual disposition information. For example, the HMD 200 records the stay position where the user 10 stayed before leaving the control area range 206 and the direction from the stay position to the video virtual object 205.

As described above, the HMD 200 extracts the viewing position and direction of the user 10 with respect to the video virtual object 205 before the pause from the information related to the position of the user 10 or the direction of the line of sight of the user 10 with respect to the video virtual object 205 recorded before the pause and acquires the viewing position and direction. Then, the HMD 200 records the viewing position and direction of the user 10 with respect to the video virtual object 205 before the pause as the mutual disposition information. In addition, as an example, the stay position can be the position where the user 10 stays when viewing the video virtual object, that is, the position where the user 10 continues to view the video virtual object 205 without moving for a predetermined period of time. Further, the mutual disposition information may be recorded as information of a position and direction having a predetermined range. Therefore, the mutual disposition information can be recorded as information indicating a rough position and direction.

Furthermore, instead of or in addition to recording the mutual disposition information, each of the disposition position where the video virtual object 205 is disposed and the position or the direction of the line of sight of the user as user information may be recorded.

After the motion of the video virtual object 205 is paused, the user 10 approaches the video virtual object 205 as represented by the arrow 211 in FIG. 3. At this time, in a case where the user 10 approaches within a predetermined distance from the video virtual object 205 and is located at and faces the same viewing position and direction as those before the pause, the HMD 200 resumes the playback operation of the video virtual object 205 of the soccer game. That is, in a case where the user 10 is located within a predetermined range based on the recorded mutual disposition information and faces the same direction as that in the recorded mutual disposition information, the HMD 200 resumes the playback operation of the video virtual object 205. In other words, the HMD 200 determines whether or not the user 10 has faced the same direction as that before the pause at the same position as that before the pause on the basis of the mutual disposition information recorded in the state before the pause and the information related to the position of the user 10 or the direction of the line of sight of the user 10 after the user approaches within the predetermined distance.

This makes it possible to immediately resume the playback operation of the video virtual object 205 without requiring any special operation by the user 10. In addition, the user 10 can restart the viewing of the video virtual object 205 in a state in which the rough viewing state before the user 10 stops the video virtual object 205 has been reproduced. Therefore, the HMD 200 can reduce a difference in the video viewed by the user 10 before stop and after playback, which occurs due to a difference in the viewing direction of the user 10, for the video virtual object 205 that is viewed differently depending on the angle. Then, the user 10 can continue to view the video virtual object 205.

Meanwhile, after the motion of the video virtual object 205 is paused, the user 10 approaches the video virtual object 205 from a position and in a direction different from the viewing position and direction for the video virtual object 205 before the pause, as represented by an arrow 221 in FIG. 4(a). Then, in a case where the user reaches a position 222, the HMD 200 creates a message 223 indicating that the viewing position and direction of the user 10 are different from the viewing position and direction of the user 10 before the pause and displays the message 223 on the display screen 208 within the range of the field of view as illustrated in FIG. 4(b) to notify the user 10 of the fact. Here, the HMD 200 can determine whether or not the viewing position and direction are different from the viewing position and direction before the pause, on the basis of the mutual disposition information recorded in the state before the pause.

FIG. 4(b) illustrates the display screen 208 within the range of the field of view of the HMD 200 and illustrates a case where a message whose content is “Notification message: Viewing position and direction are different . . . ” is generated and displayed as an example of the message 223 displayed on the display screen 208. This enables the HMD 200 to notify the user 10 that the re-entry position and direction of the user 10 into the control area range 206 are different from the viewing position and direction of the video virtual object 205 before the pause. Further, the HMD 200 can notify the user 10 that the difference in the video viewed by the user before stop and after playback occurs due to the difference in the viewing direction for the video virtual object 205 that is viewed differently depending on the angle.

In addition, the aspect of the notification is not particularly limited and may be a message as illustrated in FIG. 4(b), the display of a symbol indicating the notification, a warning by sound or vibration, or the like. For example, the HMD 200 may display a line indicating the control area range 206 as a thick line or a solid line, change the color of the displayed line, or blink the line for a predetermined period of time for the notification.

The user 10 who has received the notification can recognize that the user 10 is located at a position different from the viewing position before the pause or faces a direction different from the viewing direction before the pause. Then, after recognizing the fact, the user 10 can select, for example, whether or not to resume the motion of the video virtual object 205 without any change or whether to control the rotation or the like of the video virtual object 205 and to resume the motion of the video virtual object 205. Then, in a case where the user 10 selects to resume the motion of the video virtual object 205 without any change, the effect of allowing the user 10 to resume the viewing of the video virtual object 205 from the position and in the direction where the user 10 wants to view the video virtual object 205 is obtained.

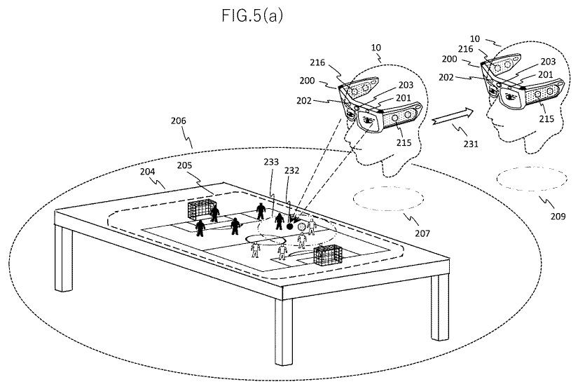

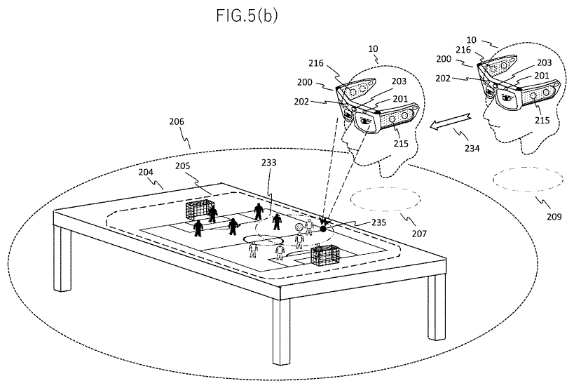

In a case where the user 10 moves a predetermined distance away from the video virtual object 205 and is located outside the control area range 206 as represented by an arrow 231 in FIG. 5(a) and the HMD 200 stops the motion of the video virtual object 205, information related to the line of sight of the user 10 is recorded. That is, as illustrated in FIG. 5(a), the HMD 200 extracts a predetermined gaze range 233 having, as its center, a gaze location 232 of the user 10 before the stop which has been specified by the left eye gaze sensor 201 and the right eye gaze sensor 202 and records the predetermined gaze range 233 as predetermined gaze range information. In addition, in a case where the line of sight of the user 10 to the video virtual object 205 does not move for a predetermined period of time, the HMD 200 specifies a location including the position of a gaze target as the gaze location 232. Alternatively, in a case where the amount of movement of the line of sight of the user 10 to the video virtual object 205 is equal to or less than a predetermined threshold value, the HMD 200 specifies a location including the position of the gaze target as the gaze location 232.

After the pause, the user 10 moves into the control area range 206, as represented by an arrow 234 in FIG. 5(b). Then, the HMD 200 discerns a position and orientation corresponding to the recorded mutual disposition information. When discerning that a gaze target 235 of the user 10 has entered the predetermined gaze range 233 indicated by the predetermined gaze range information, the HMD 200 resumes the playback operation of the video virtual object 205. Therefore, the HMD 200 can resume the playback operation of the video virtual object 205 in a state in which the gaze target 235 of the user 10 is directed to the vicinity of the gaze location 232 that the user 10 was gazing at when the motion of the video virtual object 205 was stopped. As a result, even after the playback is resumed, the user 10 can gaze at substantially the same location as that before the pause from the viewing position and in the direction before the pause and can smoothly view the video virtual object 205 whose playback has been resumed from the time point before the pause, without any discomfort. Furthermore, the HMD 200 can restart the viewing of the video virtual object 205 while reproducing the state in which the user 10 viewed the video virtual object 205 with particular attention to the video virtual object 205 before the stop.

As illustrated in FIG. 5(a) or FIG. 5(b), the video virtual object 205 is a soccer game, and the user 10 views the video virtual object 205 while paying attention to the vicinity of a soccer ball, for example. In this case, even when playback is restarted from the pause, the user 10 can continue to view the video virtual object without interruption, with a focus on the vicinity of the soccer ball to which the user 10 is paying attention.

In addition, when the user 10 re-enters the control area range 206 after the video virtual object 205 is paused, the HMD 200 may perform display which will be described below. That is, the HMD 200 may perform control to display the mutual position and direction relationship between the recorded video virtual object 205 and the position of the user 10 who has re-entered the control area range or the line of sight of the user 10 before the pause. Here, the display aspect of the mutual position and direction relationship is not particularly limited as long as each relationship can be understood. The HMD 200 may display, for example, a difference in the relationship between the position of the virtual object 205 before the pause and the current position of the HMD 200 as a numerical value. Here, in a case where the difference is smaller than a predetermined amount, the HMD 200 may perform the display of text information, voice output, or the like to notify the user of the fact. The HMD 200 may display, for example, a compass symbol indicating the direction in which the video virtual object 205 was displayed before the pause and a compass symbol indicating the current orientation of the HMD 200. In addition, the HMD 200 may perform control to generate an image of a virtual object, such as a circle, an arrow, or a point, indicating the gaze location 232 of the user 10 on the video virtual object 205 and to display the image to be superimposed on a three-dimensional space.

Therefore, when the user 10 re-enters the control area range 206, the user 10 can immediately understand the mutual position and direction relationship between the video virtual object 205 and the position of the user 10 or the line of sight of the user 10 before the pause. In addition, the user 10 can immediately understand the gaze location 232 of the user on the video virtual object 205. As a result, when the stereoscopic video virtual object 205 disposed at a specific location is viewed, the effect of simply and conveniently stopping the viewing or resuming playback by an operation at an appropriate timing corresponding to the situation, without requiring a specific operation of the user 10, is obtained.

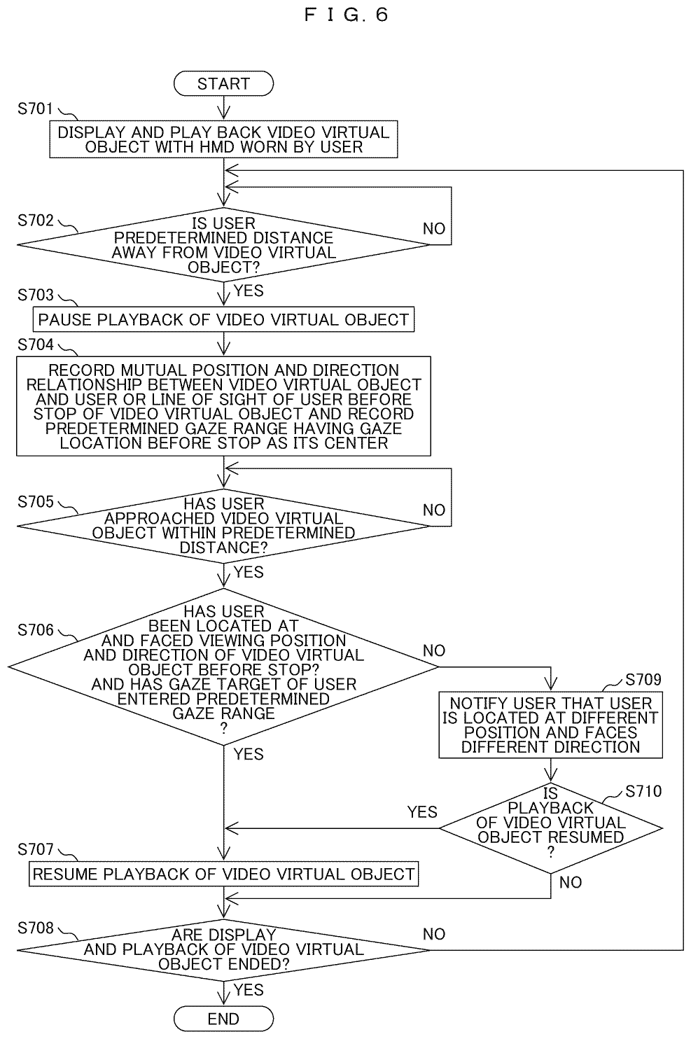

Next, a basic operation of the information processing apparatus according to this embodiment will be described with reference to a flowchart illustrated in FIG. 6. FIG. 6 is an example of the flowchart illustrating the basic operation of the information processing apparatus according to this embodiment. The basic operation of the information processing apparatus (in this example, the HMD 200) is appropriately executed using hardware resources which will be described below. In FIG. 6, the video virtual object 205 is played back and displayed by the HMD 200 worn by the user 10 (S701). Then, when the user 10 moves a predetermined distance away from the video virtual object 205 and moves out of the control area range 206 (S702), the HMD 200 pauses the playback of the video virtual object 205 (S703). At this time, the HMD 200 records, as the mutual disposition information, the mutual position and direction relationship between the video virtual object 205 and the position of the user 10 or the line of sight of the user 10 before the stop. In addition, the HMD 200 records, as the predetermined gaze range information, the predetermined gaze range having, as its center, the gaze location before the stop (S704). Then, in a state in which the motion of the video virtual object 205 is paused, the user 10 approaches the video virtual object 205 and enters the control area range 206 within a predetermined distance (S705).

Here, the HMD 200 determines whether or not the user 10 is located at the viewing position before the stop and whether or not the user 10 faces the direction before the stop (that is, whether or not the user 10 is located within a predetermined range based on the recorded mutual disposition information and whether or not the user 10 faces a predetermined direction). Furthermore, the HMD 200 determines whether or not the gaze target of the user 10 is directed to the inside of the predetermined gaze range (S706). In a case where the HMD 200 determines that the user 10 is located at the viewing position before the stop and faces the direction before the stop and that the gaze target of the user 10 is directed to the inside of the predetermined gaze range, the HMD 200 resumes the playback of the video virtual object 205 (S707). Further, when the display and playback of the video virtual object 205 are not finished, the HMD 200 returns to Sequence S702 and repeats this flow. When the display and playback of the video virtual object 205 are finished, the HMD 200 ends this flow (S708).

On the other hand, in a case where the user 10 is located at the viewing position before the stop and does not face the direction before the stop, the HMD 200 notifies the user 10 that the user 10 is at a different position and faces a different direction (S709). Here, in a case where the user 10 who has received the notification determines to resume the playback of the video virtual object 205 (S710), the user 10 inputs the determination to the HMD 200 using an appropriate method, and the HMD 200 resumes the playback of the video virtual object 205 (S707). In addition, examples of the input method by the user 10 include methods using a button operation and a gesture. At this time, the HMD 200 may resume the playback of the video virtual object 205 without any change. Alternatively, for example, the HMD 200 may rotate the video virtual object 205 to be in a posture suitable for viewing and resume the playback of the video virtual object 205.

In a case where the user 10 determines not to resume the playback of the video virtual object 205 (S710), when the display and playback of the video virtual object 205 are not finished, the HMD 200 returns to Sequence S702 and repeats this flow. When the display and playback of the video virtual object 205 are finished, the HMD 200 ends this flow (S708). An information processing apparatus (in this example, the HMD 200) that enables the user to stop the viewing of the video virtual object or to resume the playback of the video virtual object simply and conveniently, without requiring any special operation by the user, is provided by the above-described operation.

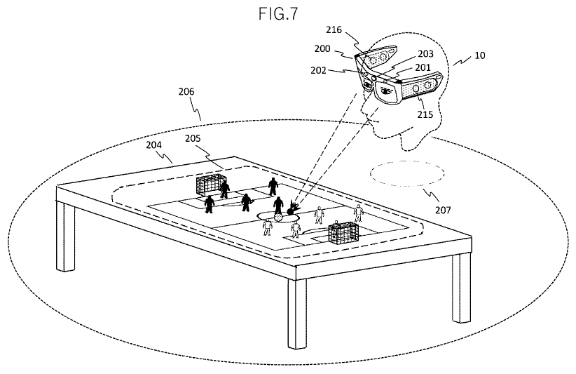

Next, the information processing apparatus in a case where the user is notified of the position or gaze point of the user before pause and the suitable viewing position and direction of the video virtual object at the time of stop will be described with reference to FIGS. 7, 8, and 9. In addition, in FIGS. 7, 8, and 9, since portions that are denoted by the same reference numerals as those in FIGS. 1, 2, 3, 4(a), 4(b), 5(a), and 5(b) have the same operations as those described in FIGS. 1, 2, 3, 4(a), 4(b), 5(a), and 5(b), a detailed description thereof will be partially omitted. In FIG. 7, the HMD 200 can capture the position of the user 10 using the positioning sensor 215 and can capture the gaze point of the user 10 on the video virtual object 205 using the left eye gaze sensor 201 and the right eye gaze sensor 202. Therefore, the HMD 200 notifies the user 10 of the position or gaze point of the user 10 captured before the pause as suitable viewing disposition information such that the user 10 can understand the viewing position of the user 10 before the video virtual object 205 is stopped.

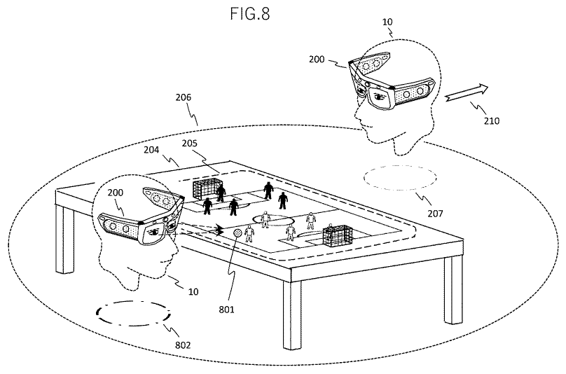

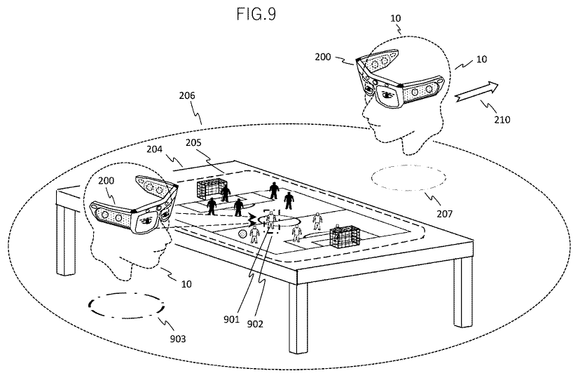

Next, FIG. 8 and FIG. 9 will be described. In addition, since the portions that are denoted by the same reference numerals as those in FIG. 7 have the same operations as those described in FIG. 7, a detailed description thereof will be partially omitted. In FIG. 8, when the user 10 moves out of the control area range 206 as represented by an arrow 210, the HMD 200 pauses the motion of the video virtual object 205 which is a soccer game video. At this time, the HMD 200 selects the position and direction of a suitable highlight of a video scene in the video virtual object 205 in the paused state as the suitable viewing disposition information and notifies the user 10 of the selected position and direction. Here, the position and direction of the suitable highlight of the video scene is a position and direction where the user sees up close the view of a virtual object or the like that the user is gazing at in the video scene without any obstructions. In the case of the soccer game video illustrated as the video virtual object 205 in FIG. 8, for example, it is assumed that the user is gazing at a soccer ball 801. Therefore, the HMD 200 selects, as the suitable viewing disposition information, a suitable viewing position and direction 802 that enables the user 10 to see the view of the soccer ball that the user is gazing at as if the view is right in front of the eyes of the user, without being obstructed by other virtual objects, and notifies the user 10 of the suitable viewing position and direction 802.

Therefore, the HMD 200 can suggest, to the user 10, a suitable viewing position and direction for a certain virtual object in the video virtual object 205 that the user 10 is gazing at. Furthermore, the user 10 can re-enter the control area range at the suggested viewing position and in the suggested direction and restart the playback of the video virtual object 205 at a suitable viewing point. In another example, the HMD 200 suggests, to the user, a suitable viewing position and direction where the user can view a soccer player in the video virtual object 205 that the user is gazing at from the front or diagonally rather than from behind, without being obstructed by other virtual objects. Therefore, it is possible to resume the playback at a suitable viewing point.

Even in FIG. 9, when the user 10 moves out of the control area range 206 as represented by the arrow 210, the HMD 200 pauses the motion of the video virtual object 205 which is a soccer game video. At this time, the HMD 200 selects, as the suitable viewing disposition information, a suitable viewing position and direction for a specific virtual object in a video of a video scene in the video virtual object 205 in the paused state and notifies the user of the suitable viewing position and direction. In the case of the soccer game video illustrated as the video virtual object 205 in FIG. 9, for example, it is assumed that a certain soccer player 901 is selected as the specific virtual object. The HMD 200 extracts the soccer player 901 surrounded by a rectangular frame 902 as the specific virtual object. Then, the HMD 200 selects, as the suitable viewing disposition information, a suitable viewing position and direction 903 where the user can view the movement of the soccer player 901 that is the specific virtual object as if the soccer player 901 is right in front of the eyes of the user, without being obstructed by other virtual objects, and notifies the user 10 of the suitable viewing position and direction 903.

Therefore, the HMD 200 can suggest, to the user 10, a position and direction where the user 10 can suitably view a virtual object, such as a virtual object designated in advance by the user 10 or an important person, in the video virtual object 205 viewed by the user 10, regardless of the gaze point of the user 10. Further, the user 10 can re-enter the control area range at the suggested viewing position and in the suggested direction and restart the playback of the video virtual object 205 at a suitable viewing point. In addition, when selecting the specific virtual object or the viewing position and direction where the specific virtual object can be viewed suitably, the HMD 200 may perform the determination on the basis of the following description. That is, the HMD 200 may record a highlight scene frequently viewed by a viewer or a specific virtual object that the viewer frequently gazes at in the soccer video, which is the video virtual object 205, and may perform the determination on the basis of this record.

As another example, the user 10 may designate a specific virtual object while viewing the video virtual object 205, and the HMD 200 may perform control to select a suitable viewing position and direction for the designated specific virtual object as the suitable viewing disposition information and to notify the user 10 of the selected suitable viewing position and direction. This enables the HMD 200 to notify the user 10 of a suitable viewing position and direction for any specific virtual object selected by the user 10.

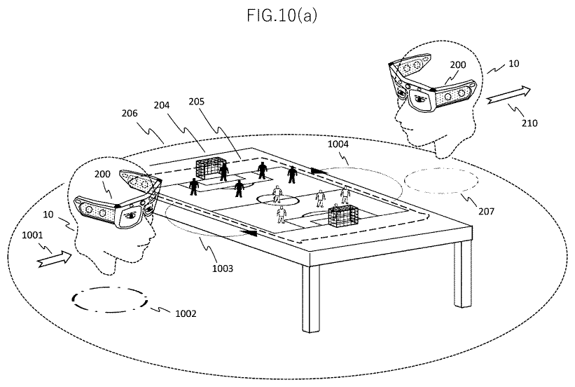

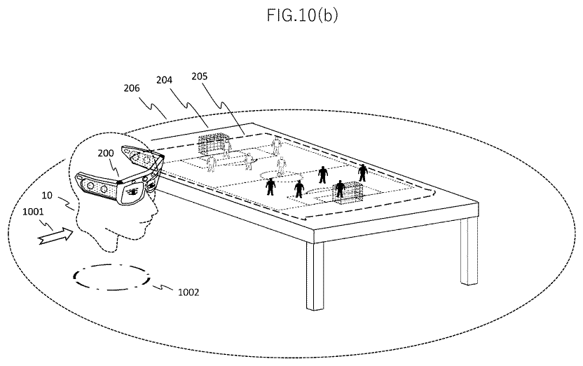

Next, the information processing apparatus in a case where, when the playback of the video virtual object is restarted after the video virtual object is stopped, posture control, such as the rotation of the video virtual object, is performed will be described with reference to FIGS. 10(a), 10(b), 11, and 12. In FIGS. 10(a), 10(b), 11, and 12, since portions that are denoted by the same reference numerals as those in FIGS. 1 to 9 have the same operations as those described in FIGS. 1 to 9, a detailed description thereof will be partially omitted. In FIG. 10(a), when the user 10 moves out of the control area range 206 as represented by the arrow 210, the HMD 200 pauses the motion of the video virtual object 205 which is a soccer game video. In addition, the HMD 200 records, as the mutual disposition information, the mutual position and direction relationship between the video virtual object 205 and the position and the line of sight of the user 10 before the stop of the video virtual object 205. After the pause, the user 10 approaches within a predetermined distance from the video virtual object 205 in a direction 1001. Here, the HMD 200 rotates the video virtual object 205 according to the approach direction 1001 of the user 10 or a position 1002 after the approach, on the basis of the recorded position and direction relationship of the position of the user 10 or the direction of the line of sight of the user 10 at the time of the stop. That is, as illustrated in FIG. 10(a), the user 10 approaches the soccer game video, which is the video virtual object 205, from a position 1002 on the opposite side in the direction 1001 that is substantially the same as the direction 210 in which the user 10 moved away. In this case, the HMD 200 rotates the soccer game vide by approximately 180 degrees as represented by arrows 1003 and 1004.

This enables the approaching user 10 to view the soccer game video in the same disposition state as that before the stop as illustrated in FIG. 10(b). That is, both before the stop and after the playback is resumed, team players wearing black uniforms can be viewed on the left side of the field of view, team players wearing white uniforms can be viewed on the right side of the field of view, and it is possible to smoothly view the soccer game video without any discomfort even after the transition from the stop to the resumption of the playback. The user 10 approaches the video virtual object 205 in a direction different from the viewing direction of the user 10 before the video virtual object 205 is stopped, or the user 10 is located in a direction different from the viewing direction of the user 10 before the video virtual object 205 is stopped after approaching the video virtual object 205. Even in this case, the user 10 can resume the viewing of the video virtual object 205 in a state in which the rough viewing state before the stop of the video virtual object 205 is reproduced, without moving to the viewing position or in the viewing direction before the stop.

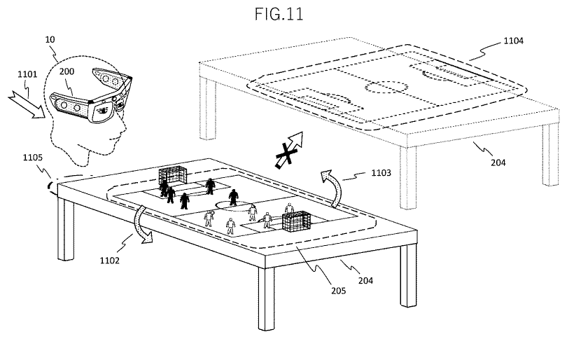

FIG. 11 illustrates a case where, after the pause, the user 10 approaches the soccer game video, which is the video virtual object 205, in a direction 1101 that is substantially perpendicular to the direction 210 in which the user 10 moved away. Here, it is considered that the video virtual object 205 is rotated by approximately 90 degrees in a direction indicated by arrows 1102 and 1103 according to the approach direction 1101 of the user 10, on the basis of the recorded position and direction relationship of the user 10 and the line of sight of the user 10 at the time of the stop. In this case, as illustrated in FIG. 11, a soccer game video 1104 rotated by approximately 90 degrees protrudes from the top of the desk 204. Therefore, in a case where the video virtual object 205 is not contained within the disposition location, such as the desk 204, due to the size or shape of the disposition location when it is rotated, the HMD 200 does not rotate the video virtual object 205. This makes it possible to prevent the occurrence of a misalignment between the video virtual object 205 and the disposition location due to the rotation of the video virtual object 205.

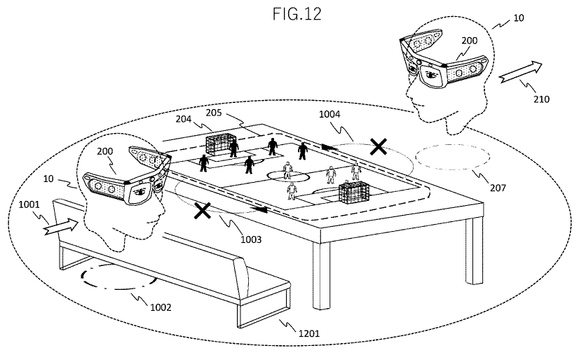

FIG. 12 illustrates a case where, after the pause, the user 10 approaches the video virtual object 205 in the direction 1001 as in the case illustrated in FIG. 10(a). Here, when a specific viewing location, such as a chair 1201, is present in the control area range 206 containing the video virtual object 205, the HMD 200 does not rotate the soccer game video which is the video virtual object 205. In this case, since there is a high possibility that the user will resume the viewing of the video virtual object 205 while sitting in the chair or from the specific viewing location, the HMD 200 deliberately does not rotate the video virtual object 205 to enable the user to view the video virtual object without any particular discomfort. In addition, in a case where there is another viewer, it is beneficial not to rotate the video virtual object in order to avoid affecting the viewing of another viewer. Therefore, the effect of controlling the playback of the video virtual object 205 or notifying the user 10 in consideration of the situation of the viewing location of the video virtual object 205 is obtained.

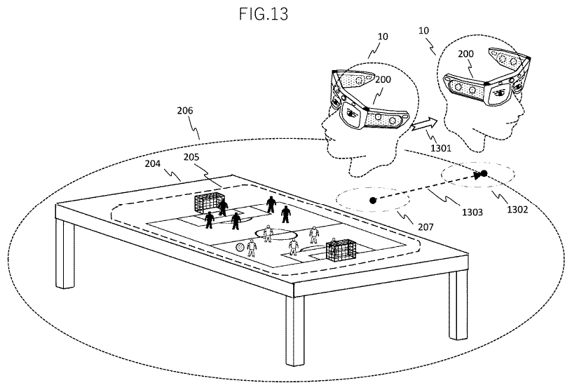

Next, the information processing apparatus in a case where, when the video virtual object is played back, a playback position (playback time position) of the video virtual object is returned to a previous position will be described with reference to FIGS. 7 and 13. When the user approaches within a predetermined distance from the paused video virtual object, the information processing apparatus performs a process on the basis of the recorded mutual disposition information, information related to the playback position of the video virtual object 205, and information related to the position of the user or the direction of the line of sight of the user after the user approaches within the predetermined distance. In addition, in FIG. 13, since portions that are denoted by the same reference numerals as those in FIGS. 1 to 5 and FIGS. 7 to 12 have the same operations as those described in FIGS. 1 to 5 and FIGS. 7 to 12, a detailed description thereof will be partially omitted.

When the user 10 is located within the control area range 206, the gaze target of the user 10 is directed toward the video virtual object 205 as illustrated in FIG. 7. Then, when the user 10 tries to move out of the control area range 206, the gaze target of the user 10 moves away from the video virtual object 205. Here, the HMD 200 records the playback position of the video virtual object 205 when the user 10 moved the line of sight away. In addition, when the user 10 moves out of the control area range 206, the motion of the video virtual object 205 is stopped. Therefore, when the user 10 approaches the paused video virtual object 205, the HMD 200 performs a process which will be described below, on the basis of the recorded mutual disposition information, the information related to the playback position of the video virtual object 205, and the information related to the position of the user and the direction of the line of sight of the user after the user approaches within the predetermined distance. That is, when resuming the playback of the motion of the video virtual object 205 on the basis of the information, the HMD 200 does not play back the video virtual object 205 from the playback position where the motion of the video virtual object 205 was stopped (the position when the video was stopped). The HMD 200 plays back the video virtual object 205 from the playback position of the video virtual object 205 when the user 10 moved the gaze target away from the video virtual object 205 or the playback position that is a predetermined time before the user 10 moved the gaze target away from the video virtual object 205. That is, the HMD 200 plays back the video virtual object 205 from a playback position that is earlier in time than the playback position where the motion of the video virtual object 205 was stopped, for example, from the playback position when the user 10 moved the line of sight away or the playback position that is a predetermined time before the user 10 moved the gaze target away. This enables the user 10 to also view the video that was played back for the period from the time the user 10 moved the light of sight away from the video virtual object 205 to the time the user 10 moved out of the control area range 206.

FIG. 13 is a diagram illustrating an example of a process performed by the information processing apparatus on the basis of the recorded mutual disposition information and information related to the position of the user and the direction of the line of sight of the user after the user approaches within a predetermined distance when the user approaches within the predetermined distance from the paused video virtual object. That is, FIG. 13 is a diagram illustrating an example of a case where, when playing back the video virtual object, the information processing apparatus plays back the video virtual object from the playback position moved back by the time taken for the user to move from a user stay position within the control area range to the position where the user leaves the control area range. In FIG. 13, the user 10 is located at the position 207 within the control area range 206 and is viewing the motion of the video virtual object 205. Then, when the user 10 moves to a position 1302 and leaves the control area range 206 without directing the line of sight toward the video virtual object 205 for a predetermined period of time as represented by an arrow 1301, the motion of the video virtual object 205 is stopped. Then, the user 10 approaches the paused video virtual object 205, and the HMD 200 plays back the video virtual object 205 on the basis of the recorded mutual disposition information and the information related to the position of the user or the direction of the line of sight of the user after the user approaches within a predetermined distance.

However, at this time, when the motion of the video virtual object 205 is played back from the playback position where the user 10 moved the line of sight away from the video virtual object 205, the playback restarting position may not be the playback restarting position that the user 10 considers preferable. In this case, for example, a playback position when the user 10 starts moving from the position 207 towards the position 1302 is considered as the playback restarting position that the user 10 considers preferable. Therefore, the HMD 200 records the time until the user 10 leaves the control area range 206 without directing the line of sight toward the video virtual object 205 or the time taken for user movement 1303 from the user stay position to the position where the user leaves the control area range 206. Then, in a case where the user 10 moves to the position 1302 and leaves the control area range 206 without directing the line of sight toward the video virtual object 205 for a predetermined period of time, the HMD 200 plays back the video virtual object 205 from the playback position moved back by the user movement time.

Therefore, when the user 10 approaches within a predetermined distance from the paused video virtual object, the HMD 200 plays back the video virtual object without interruption on the basis of the recorded mutual disposition information and the information related to the position of the user 10 or the direction of the line of sight of the user after the user 10 approaches within the predetermined distance. As a result, when the video virtual object is played back, the user 10 can view the motion of the video virtual object 205 without interruption from the playback position of the video virtual object 205 that the user 10 viewed at the position 207.

In addition, the HMD 200 can determine the viewing importance of the user for the video virtual object 205 on the basis of information related to the time until the user 10 leaves the control area range 206 without directing the line of sight toward the video virtual object 205. Then, the HMD 200 may appropriately select the playback position according to the determination. The HMD 200 can perform playback control such as selection of the rewind time. For example, the HMD 200 plays back the video virtual object 205 in a form in which the video virtual object 205 is rewound by the user movement time or plays back the video virtual object 205 from the playback position when the user 10 moved the line of sight away from the video virtual object 205.

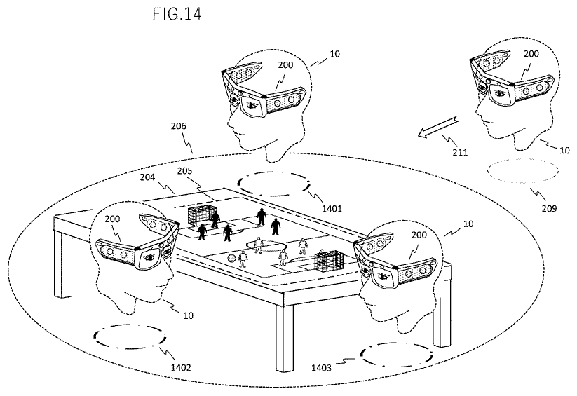

Next, the information processing apparatus in a case where, when the user approaches within a predetermined distance from the paused video virtual object, a plurality of playback position candidates are presented as the playback positions of the video virtual object and a playback position is selected according to the viewing importance of the playback position of the video virtual object and is notified will be described with reference to FIG. 14. In FIG. 14, since portions that are denoted by the same reference numerals as those in FIGS. 1 to 5 and FIGS. 7 to 13 have the same operations as those described in FIGS. 1 to 5 and FIGS. 7 to 13, a detailed description thereof will be partially omitted. As illustrated in FIG. 14, when the user 10 approaches the paused video virtual object whose operation is stopped and moves into the control area range 206, the HMD 200 selects a plurality of playback position candidates, such as user positions 1401, 1402, and 1403, as the positions where the playback of the video virtual object 205 is viewed. Here, the HMD 200 displays a message image showing the reason for selecting each playback position candidate and information related to the playback position of the video virtual object for notification. The HMD 200 generates an image of a virtual object, such as a circle, an arrow, or a point, indicating each position and direction (each viewing position and direction) relationship between the video virtual object and the position and the line of sight of the user and the gaze location at each playback position candidate and displays the image to be superimposed on the three-dimensional space for notification. Then, the user 10 is located at the viewing position and in the direction or gazes at the gaze location at one of the selected playback position candidates. Then, the HMD 200 restarts the playback of the video virtual object from the playback position of the playback position candidate corresponding to the viewing position and direction relationship or the gaze location.

In addition, the playback position candidates are selected on the basis of information such as the length of the gaze time of the user 10, the frequency of the gaze, a highlight scene (a scene that has the largest total number of views and includes information related to viewing by other viewers), and each viewing position and direction relationship. For example, a start playback position of a scene that the user 10 gazed at for a long time is presented as a candidate together with information related to the viewing position and direction relationship. In addition, the information of the viewing position and the direction at the playback position candidate is recorded as information of a position and direction having a predetermined range. The selection of the playback position candidates in this way enables the user to review important scenes when resuming the viewing of the video virtual object or to resume viewing while omitting unimportant scenes in a case where the user can no longer find time to view the video virtual object for a long time.

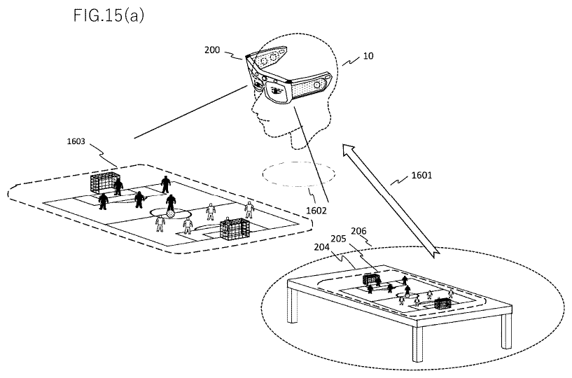

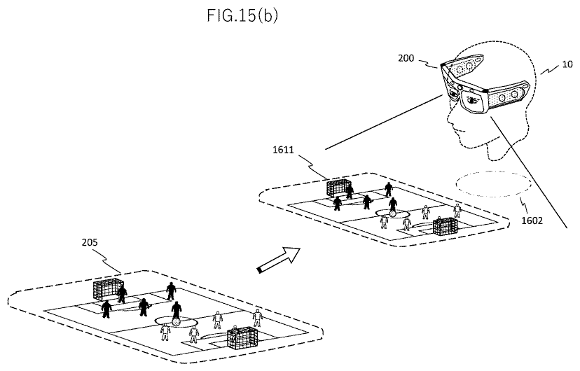

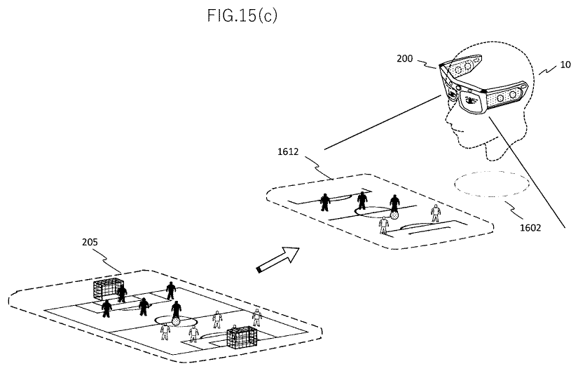

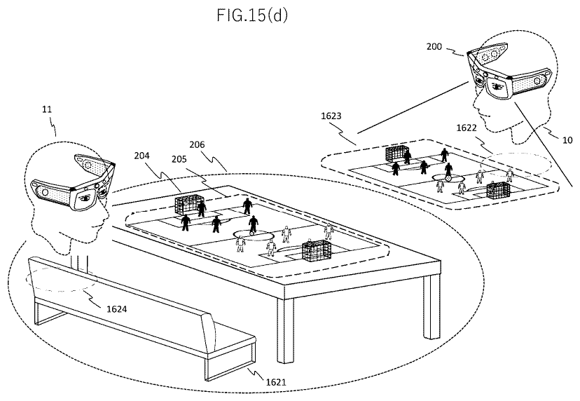

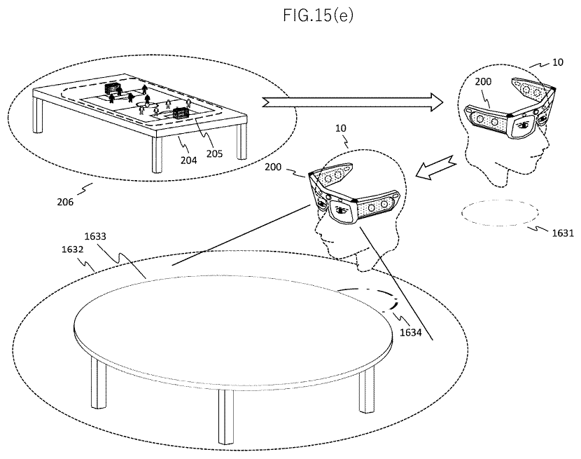

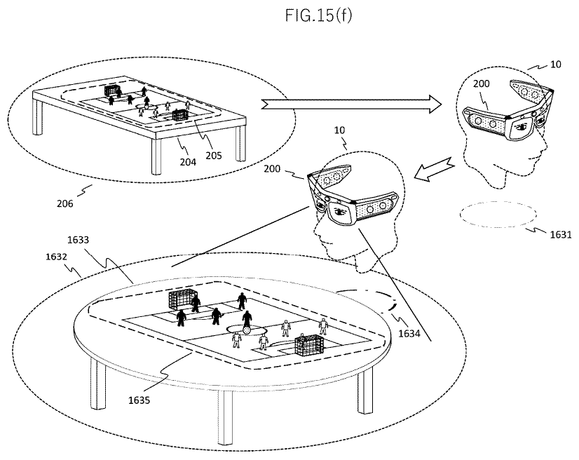

Next, the information processing apparatus in a case where, after the user leaves the control area range and the motion of the video virtual object is paused, the video virtual object is newly fixedly disposed will be described with reference to FIG. 15. In the example illustrated in FIG. 15, the HMD 200 changes the position and direction of the video virtual object 205 according to the movement of the HMD 200 in a state in which the mutual position and direction relationship between the video virtual object 205 and the position of the user 10 or the line of sight of the user 10 at the time of the pause is maintained. Various coordinate systems are used in a process of representing stereoscopic real objects and virtual objects. The three-dimensional world coordinate system is a coordinate system that is considered in the world which a geometric model of a real space or a virtual space is considered. In the three-dimensional world coordinate system, the position and direction of the video virtual object 205 are not changed even when the HMD 200 is moved. Meanwhile, there is a coordinate system of a model that is suitable for representing each part of a three-dimensional model, and there is a local coordinate system of the three-dimensional model relative to the world coordinate system. In the local coordinate system of the HMD 200, the video virtual object 205 is fixedly disposed such that the position and direction of the video virtual object 205 are changed according to the movement of the HMD 200 to follow the movement of the HMD 200. FIG. 15 illustrates an example of the local coordinate system of the HMD 200. That is, FIG. 15 illustrates a case where the position and direction of the video virtual object 205 are changed according to the movement of the HMD 200 in a state in which the mutual position and direction relationship between the video virtual object 205 and the user 10 and the line of sight of the user 10 at the time of the pause is maintained. In FIG. 15, since portions that are denoted by the same reference numerals as those in FIGS. 1 to 5 and FIGS. 7 to 14 have the same operations as those described in FIGS. 1 to 5 and FIGS. 7 to 14, a detailed description thereof will be partially omitted.

FIG. 15(a) illustrates a case where a predetermined time has elapsed since the user 10 left the control area range 206 and moved to a position 1602 and the motion of the video virtual object 205 was paused as represented by an arrow 1601. In this case, the HMD 200 changes the position and direction of the video virtual object 205 according to the movement of the HMD 200 in a state in which the mutual position and direction relationship between the video virtual object 205 and the user 10 and the line of sight of the user 10 at the time of the pause is maintained. Then, the HMD 200 newly fixedly disposes the video virtual object as illustrated in a video virtual object 1603 and notifies the user 10 whether or not to resume the playback operation of the video virtual object.

Further, in the notification at this time, the HMD 200 displays, on the display screen of the HMD 200, a selection screen that allows the user 10 to select whether or not to newly fixedly dispose the video virtual object at the gaze position of the user 10 or whether or not to resume the playback operation. Then, the HMD 200 newly fixedly disposes the video virtual object 205 or performs the playback operation of the video virtual object 205 on the basis of the selection result of the user 10 who has received the notification. That is, the HMD 200 notifies the user 10 whether or not to fixedly dispose the video virtual object 205 in the local coordinate system of the HMD 200 and to play back the video virtual object 205 and controls the fixed disposition or the playback on the basis of the selection result of the user 10 in response to the notification. Therefore, the user 10 can resume the viewing of the video virtual object 205 in a state in which the mutual position and direction relationship between the video virtual object 205 and the user 10 and the line of sight of the user 10 at the time of the pause is maintained. As a result, even in a case where the user 10 is not able to return to the disposition location of the video virtual object 205, the user 10 can appropriately resume the viewing of the video virtual object 205.

Further, in a case where the size of the video virtual object 205 is larger than a predetermined threshold value when the video virtual object 205 is fixedly disposed in the local coordinate system of the HMD, the HMD 200 performs a process which will be described below. That is, as illustrated in FIG. 15(b), the HMD 200 fixedly disposes a reduced video virtual object 1611 in the local coordinate system of the HMD 200, displays the reduced video virtual object 1611, and resumes the playback operation of the video virtual object 1611. In addition, similarly, in a case where the size of the video virtual object 205 is larger than the predetermined threshold value when the video virtual object 205 is fixedly disposed in the local coordinate system of the HMD, the HMD 200 performs a process which will be described below. As illustrated in FIG. 15(c), the HMD 200 fixedly disposes a video virtual object 1612 generated by extracting a region of a predetermined range including the gaze location of the video virtual object in the local coordinate system of the HMD 200, displays the video virtual object 1612, and resumes the playback operation of the video virtual object 1612. Therefore, it is possible to resume the viewing of the playback operation of the video virtual object while ensuring the field of view of the user 10 outside the video virtual object. As a result, viewing can be conveniently stopped or resumed by an operation at an appropriate timing corresponding to the situation of the user or the disposition situation of a stereoscopic video virtual object.

Next, the fixed disposition and playback operation of the video virtual object in a case where the user moves away from the control area range when a specific viewing location, such as a chair, or another viewer is present within the control area range will be described with reference to FIG. 15(d). FIG. 15(d) illustrates a case where a chair 1621, which is the specific viewing location, or another viewer 11 is present at a position 1624 within the control area range 206. In this case, when a predetermined time has elapsed since the user 10 moved out of the control area range 206, the HMD 200 duplicates the video virtual object in a state in which the position and direction relationship between the video virtual object and the position of the user or the line of sight of the user before the pause is maintained. Then, the HMD 200 newly fixedly disposes a duplicated video virtual object 1623 and notifies the user 10 whether or not to play back the motion of the video virtual object 1623. Further, in the notification at this time, the HMD 200 displays, on the display screen of the HMD 200, a selection screen that allows the user 10 to select whether to perform a new fixed disposition or the resumption of the playback operation by gazing. Then, the HMD 200 controls the new fixed disposition and the playback operation of the video virtual object 1623 on the basis of the selection result of the user 10 who has received the notification.

As described above, the video virtual object is duplicated, is newly fixedly disposed, and is played back, which makes it possible for the user who has left the control area range to resume the viewing of the video virtual object in a different location while maintaining the original disposition position and direction of the video virtual object. That is, while considering the situation of the original viewing location of the video virtual object, the user who has left the control area range can view the video virtual object in another location before returning to the original disposition location.

In addition, for example, there is a case where a plurality of users, each wearing the HMD, view a video of a virtual object (hereinafter, sometimes referred to as a video virtual object) together in the use of the HMD. In this case, it is considered that the video virtual object is first disposed in a suitable space and then the users view the video virtual object. In addition, it is considered to similarly respond to, for example, a case where the user wants to view the video virtual object in the same way as the user views a real object and a case where the video virtual object is displayed at an obstructive position on the screen of the HMD.

Further, in a case where the user returns to the original position after resuming the viewing of the video virtual object, the HMD 200 erases the newly fixedly disposed video virtual object 1623. Therefore, only the original video virtual object 205 is fixedly disposed, and it is possible to eliminate the confusion caused by an unnecessary video object. Furthermore, in a case where a specific viewing location, such as a chair, is present, but no other viewers are present, the HMD 200 may perform a process which will be described below. That is, the HMD 200 restarts the originally disposed video virtual object 205 from a playback position that is advanced by the viewing time for the newly fixedly disposed video virtual object 1632. This makes it possible to play back the originally disposed video virtual object and the newly fixedly disposed video virtual object in synchronization with each other.

On the other hand, in a case where a specific viewing location, such as a chair, or another viewer is present within the control area range, when the resumption of viewing at that location is prioritized, the HMD 200 may perform control not to fixedly dispose the video virtual object in the local coordinate system of the HMD and not to play back the video virtual object. This makes it possible to avoid impeding the action of the user until the user returns to the disposition location of the video virtual object and enables the user to quickly return to the disposition location of the video virtual object.

In addition, the settings of each control process illustrated in FIGS. 15(b) to 15(d) may be changed according to the user's preference.

Next, a case will be described where, when the user approaches another possible disposition location, the video virtual object is newly fixedly disposed in a state in which the mutual position and direction relationship between the video virtual object and the position of the user or the line of sight of the user at the time of the pause is maintained and the playback operation of the video virtual object is resumed. FIG. 15(e) illustrates a case where the user 10 moves away from the control area range 206, moves to a position 1631, approaches a round table 1633, which is another possible disposition location within a control area range 1632, and moves to a position 1634. Here, in a case where the user 10 approaches the round table 1633 which is another possible disposition location, the HMD 200 performs a process which will be described below, as illustrated in FIG. 15(f). The HMD 200 determines whether or not a video virtual object 1635 can be fixedly disposed on the round table 1633, which is another possible disposition location, in a state in which the mutual position and direction relationship between the video virtual object 205 and the position of the user or the line of sight of the user at the time of the pause is maintained. Here, when determining that the video virtual object can be fixedly disposed, the HMD 200 notifies the user 10 that the video virtual object can be fixedly disposed.

Further, in the notification at this time, the HMD 200 displays, on the display screen of the HMD 200, a selection screen that allows the user 10 to select whether to perform a new fixed disposition or the resumption of the playback operation by gazing. Then, the HMD 200 controls the new fixed disposition and the playback operation of the video virtual object 1635 on the basis of the selection result of the user 10 who has received the notification. Therefore, even in a case where the user changes the disposition location of the video virtual object, the user can resume the viewing of the video virtual object in a state in which the mutual position and direction relationship between the video virtual object and the position of the user or the line of sight of the user before the time of the pause is maintained. As a result, viewing can be conveniently stopped or resumed by an operation at an appropriate timing corresponding to the situation of the user.

In addition, the round table 1633 is an example of another possible disposition location, and other examples may be used. In addition, the case where the round table 1633, which is another possible disposition location, is located within the control area range 1632 has been described. However, the round table 1633 may be located outside the control area range 1632. Further, in a case where a specific viewing location, such as a chair, or another viewer is present within the original control area range, the HMD 200 may perform control to notify the user that the video virtual object can be newly fixedly disposed at another location and not to execute fixed disposition and playback control. This provides the effect of performing notification and fixed disposition and playback control considering the situation of the original viewing location of the video virtual object.

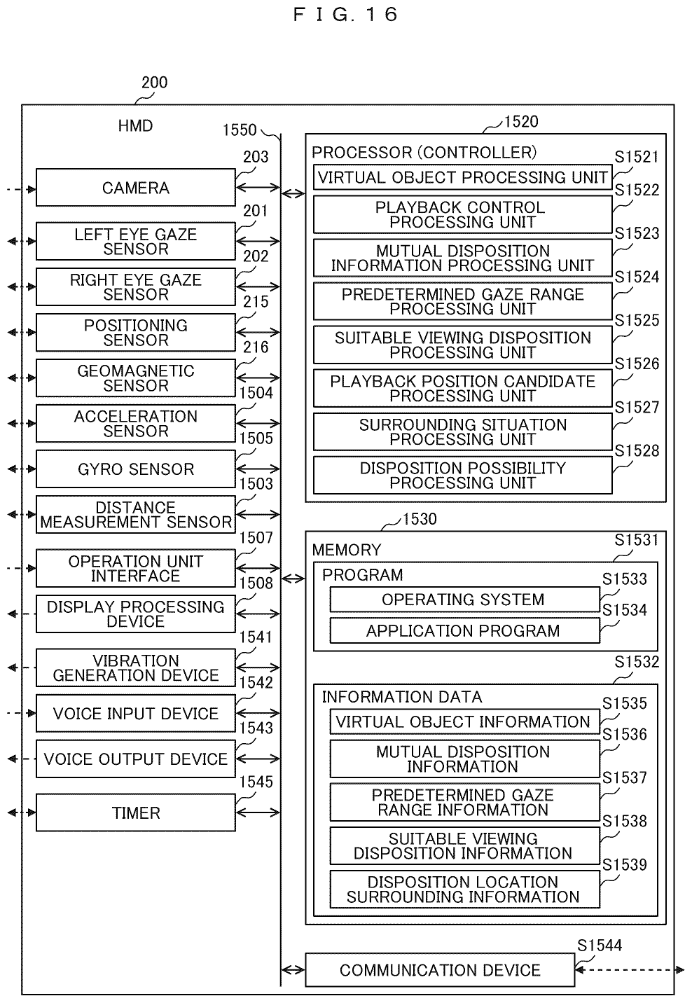

An example of the configuration of the information processing apparatus according to this embodiment will be described with reference to FIG. 16. FIG. 16 is a block diagram illustrating an example of the configuration of the HMD as an example of the information processing apparatus according to this embodiment. In FIG. 16, portions that are denoted by the same reference numerals as those in FIG. 1, FIGS. 3 to 5, and FIGS. 7 to 15 have the same operations as those described in FIG. 1, FIGS. 3 to 5, and FIGS. 7 to 15. Therefore, a detailed description thereof will be partially omitted. In FIG. 16, the HMD 200 is configured appropriately using the left eye gaze sensor 201, the right eye gaze sensor 202, the camera 203, the positioning sensor 215, the geomagnetic sensor 216, an acceleration sensor 1504, a gyro sensor 1505, an operation input interface 1507, a display processing device 1508, a processor 1520, a memory 1530 that stores a program 1531 and information data 1532, a vibration generation device 1541, a voice input device 1542, a voice output device 1543, and a communication device 1544, and the components are connected to each other through a bus 1550.

The camera 203 is a device that images the surrounding field of view in front of the camera and converts light incident from a lens into an electric signal with an image sensor to acquire a camera-captured image. The camera 203 is appropriately provided so as to capture the field of view in front of the eyes of the user 10. In the video see-through HMD, the camera 203 captures an image of a real object in a real space, such as the desk 204, and the HMD 200 displays the captured image of the real object on the display processing device 1508.

The left eye gaze sensor 201 and the right eye gaze sensor 202 can detect the movement and direction of the left eye and the right eye, respectively, and capture the gaze target of the user 10. In addition, a well-known technology that is generally used as an eye tracking process may be used in a process of detecting the movement of the eyeballs. For example, in a method using corneal reflex, a technology is known in which a face is irradiated with an infrared light emitting diode (LED), an infrared camera captures the infrared light, the position of reflected light, which has been obtained by the irradiation with the infrared LED, on the cornea (corneal reflex) is used as a reference point, and the movement and the lines of sight of the eyeballs are detected on the basis of the position of the pupil with respect to the position of the corneal reflex.

An example of the positioning sensor 215 is a Global Positioning System (GPS). The positioning sensor 215 is a device that receives radio signals from artificial satellites and detects the current position and can specify the current position of the user 10 wearing the HMD 200. As another example, a camera or a distance measurement sensor (which will be described below) may be used as the positioning sensor. The current position can be calculated by analyzing images captured by the camera or three-dimensional point cloud data measured by the distance measurement sensor, and a technology, such as Simultaneous Localization and Mapping (SLAM), is known. In addition, a geomagnetic sensor, an acceleration sensor, or a gyro sensor, which will be described below, may be used as the positioning sensor. The current position can be calculated as a relative position from a reference position, and a technology, such as Pedestrian Dead Reckoning (PDR), is known. Further, positioning may also be performed using Wi-Fi. The current position can be calculated by detecting differences in the strength and arrival time of radio waves from a plurality of Wi-Fi access points and performing three-point positioning.

The geomagnetic sensor 216 is a sensor that measures the earth's magnetic field and detects the facing direction and can detect the direction in which the user wearing the HMD 200 is facing. A three-axis-type sensor that detects the earth's magnetic field in an up-down direction in addition to the front-back and left-right directions is used to capture geomagnetic changes in response to the movement of the HMD 200, which makes it possible to detect the movement of the HMD 200.

The acceleration sensor 1504 is a sensor that detects acceleration, which is a change in speed per unit time, and can capture movement, vibration, shock, and the like. In a case where the applied acceleration is only gravity, the acceleration sensor 1504 can calculate an inclination angle, using a gravity vector and the projection of the gravity vector onto the axis of the acceleration sensor, and measure and detect how much the device is inclined relative to the ground. The inclination of the HMD 200 can be detected by the acceleration sensor 1504 provided in the HMD 200. In addition, the gyro sensor 1505 is a sensor that detects angular velocity in a rotational direction and can capture the state of vertical, horizontal, and diagonal postures. The gyro sensor 1505 can measure and detect a movement direction and the amount of movement. Therefore, the acceleration sensor 1504 and the gyro sensor 1505 can be used to detect the posture, such as direction, of the HMD 200.

The distance measurement sensor 1503 is a sensor that can measure a distance to an object and the angle of the object and capture the shape of the object, such as a thing, as a three-dimensional object. For example, Light Detection and Ranging (LiDAR) is used which irradiates an object with laser light, such as infrared rays, measures scattered light from the object, and analyzes and detects the distance to the distant object and the state of the object. For example, a Time-Of-Flight (TOF) sensor may be used which measures the reflection time of pulsed light emitted to an object for each pixel to measure the distance. For example, a millimeter wave radar may be used which emits millimeter radio waves, captures reflected waves of the millimeter radio waves, and detects the distance to the object, from which the millimeter radio waves are reflected, and the state of the object. The distance measurement sensor 1503 measures the distance to a real object, such as the desk 204, and the direction of the real object, and the HMD 200 can check, for example, that the video virtual object 205 is disposed on the desk 204 on the basis of the measurement information.

The processor 1520 is configured using an appropriate semiconductor device such as a CPU. The processor 1520 executes an operating system (OS) 1533 and an application program 1534 for operation control and the like stored in the memory 1530 to control each component of the HMD 200 and to implement the functions of the OS, middleware, applications, and the like and other functions. The HMD 200 includes a virtual object processing unit 1521, a playback control processing unit 1522, a mutual disposition information processing unit 1523, a predetermined gaze range processing unit 1524, a suitable viewing disposition processing unit 1525, a playback position candidate processing unit 1526, a surrounding situation processing unit 1527, and a disposition possibility processing unit 1528. These units (1521 to 1528) are program modules executed by the processor 1520, and the HMD 200 controls each functional operation using these units (1521 to 1528).

The memory 1530 is configured by a non-volatile storage device or the like and stores various programs 1531 and information data 1532 handled by the processor 1520 and the like. Virtual object information 1535, mutual disposition information 1536, predetermined gaze range information 1537, suitable viewing disposition information 1538, disposition location surrounding information 1539, and the like are stored as the information data 1532.

In the case of the optical see-through HMD, the display processing device 1508 can be configured to include a projection unit that projects the virtual object and notification information to be sent to the user and a transparent half mirror that forms an image of the projected virtual object or the like and displays the image in front of the user's eyes. This enables the user to view both the real object in the range of the field of view in front of the eyes and the formed image of the virtual object as if they are floating. Further, in the case of the video see-through HMD, the display processing device 1508 can be configured to include a display, such as a liquid crystal panel, that displays both the real object in front of the eyes captured by the camera 203, the virtual object, and the like together. This enables the user 10 to view the real object in the image of the field of view in front of the eyes, the virtual object, and the like which have been superimposed on each other.

The operation input interface 1507 is an input means, such as a keyboard, key buttons, or touch keys, and is configured to allow the user 10 to set and input information that the user wants to input. The operation input interface 1507 may be provided at a position and in a form that allows the user 10 to easily perform an input operation in the HMD 200, or may be separated from a main body of the HMD 200 and connected to the HMD 200 in a wired manner or wirelessly. In addition, the HMD 200 may display an input operation screen in a display screen of the display processing device 1508 and acquire input operation information on the basis of the position, to which the line of sight is directed, on the input operation screen. Further, the HMD 200 may display a pointer on the input operation screen and acquire input operation information input by the operation of the pointer by the user through the operation input interface 1507. Furthermore, the user 10 may utter a voice indicating an input operation, and the HMD 200 may collect the voice using the voice input device 1542 to acquire input operation information. Moreover, gestures corresponding to predetermined operations may be registered, and the HMD 200 may acquire an operation motion of the user using the camera 203 or the like to acquire input operation information.

The voice input device 1542 is a device that collects an external voice or the voice uttered by the user using a microphone and converts the external voice or the voice of the user into voice data. The HMD 200 can acquire instruction information by the voice uttered from the user 10 in the HMD 200 and conveniently execute an operation in response to the instruction information.

The voice output device 1543 can output a voice from a speaker on the basis of voice data to provide notification information to the user 10 by voice. For example, in a case where the user 10 is located at a position or faces a direction different from the viewing position or direction before the pause within the control area range 206, a voice is emitted to inform the user that the viewing position and direction are different from the viewing position and direction before the pause.

The vibration generation device 1541 generates vibrations under the control of the processor 1520 and converts the notification instruction information for the user 10 transmitted by the HMD 200 into vibrations. The vibration generation device 1541 transmits the vibrations to the head of the user wearing the HMD 200 to notify the user 10 of the notification instruction information, which makes it possible to improve usability.

The communication device 1544 is a communication interface that wirelessly communicates with other devices using near field communication. The communication device 1544 includes a communication processing circuit, an antenna, and the like corresponding to various predetermined communication interfaces and transmits and receives various types of information, control signals, and the like. In addition, the communication device 1544 may include a telephone communication network.

A timer 1545 measures, for example, the time until the user 10 leaves the control area range 206 without directing the light of sight toward the video virtual object 205, the time taken for the user movement 1303 from the stay position of the user to the position where the user leaves the control area range, and the time elapsed since the user 10 left the control area range 206. The time measured by the timer 1545 is recorded in the memory 1530 by the processor 1520.

The virtual object processing unit 1521 generates the stereoscopic video virtual object 205, such as a soccer game video, and disposes the video virtual object 205 in the three-dimensional space. In addition, the virtual object processing unit 1521 records information related to the position and direction of the disposed video virtual object 205 in the memory 1530. Further, in a case where the user 10 is outside the control area range 206 for a predetermined period of time, the virtual object processing unit 1521 performs a process which will be described below. That is, the virtual object processing unit 1521 changes the position and direction of the video virtual object according to the movement of the HMD 200 in a state in which the mutual position and direction relationship between the video virtual object and the user and the line of sight of the user at the time of the pause. Then, the virtual object processing unit 1521 newly fixedly disposes the video virtual object in the local coordinate system of the HMD 200. Furthermore, in a case where the video virtual object 205 is fixedly disposed in the local coordinate system of the HMD 200, when the size of the video virtual object is larger than a predetermined threshold value, the virtual object processing unit 1521 performs a process which will be described below. That is, the virtual object processing unit 1521 reduces the video virtual object 205, or extracts a region of a predetermined range including the gaze location on the video virtual object recorded by the predetermined gaze range processing unit 1524 which will be described below and disposes the region.

In addition, when the user 10 re-enters the control area range 206 after the video virtual object is paused, the virtual object processing unit 1521 performs a process which will be described below. That is, the virtual object processing unit 1521 generates a virtual object indicating the mutual position and direction relationship between the video virtual object 205 and the user 10 or the line of sight of the user 10 before the pause of the recorded video virtual object and the gaze location 232 of the user on the video virtual object 205 of the user 10, and displays the generated virtual object. For example, the virtual object processing unit 1521 generates an image of a virtual object, such as a circle, an n arrow, or a point, indicating the above-described information and displays the image to be superimposed on the three-dimensional space. In addition, the virtual object processing unit 1521 generates an image of a virtual object of a message image showing the reason for selecting the playback position candidates of the video virtual object and information related to the playback position of the video virtual object and displays the generated image to be superimposed on the three-dimensional space. Moreover, the virtual object processing unit 1521 generates an image of a virtual object, such as a circle, an arrow, or a point, indicating information related to each position and direction (each viewing position and direction) relationship between the video virtual object and the user at the playback position candidates and displays the generated image to be superimposed on the three-dimensional space.

When the user 10 is a predetermined distance away from the video virtual object 205, the playback control processing unit 1522 pauses the motion of the video virtual object 205. Then, when the user 10 approaches within the predetermined distance from the video virtual object 205, the playback control processing unit 1522 performs a process which will be described below. That is, the playback control processing unit 1522 controls the playback operation of the paused video virtual object 205 on the basis of the recorded mutual disposition information, information related to the position of the user or the line of sight of the user after the user approaches within the predetermined distance, information related to the playback position candidates of the video virtual object 205, and the like. Examples of the control of the playback operation include playing back the video virtual object without any change and rotating the video virtual object 205 and then playing back the video virtual object 205. In addition, for example, the playback control processing unit 1522 rewinds the video virtual object 205 by a predetermined amount of time and plays back the video virtual object 205, on the basis of information related to the viewing importance of the user for the video virtual object and the viewing importance of the playback position of the video virtual object or the like. Further, the playback control processing unit 1522 controls the playback and stop operations of the video virtual object 205 fixedly disposed in the local coordinate system of the HMD 200.

The mutual disposition information processing unit 1523 acquires the mutual position and direction relationship between the video virtual object and the position of the user or the line of sight of the user before the stop of the video virtual object, generates the mutual disposition information, and records the mutual disposition information in the memory 1530. For example, the mutual disposition information processing unit 1523 records, as the mutual disposition information, the position and direction of the user 10 or the line of sight of the user 10 with respect to the video virtual object 205 at the stay position where the user 10 stayed before leaving the control area range 206. Here, the stay position is, for example, a movement start position when the user 10 moves out of the control area range 206. This stay position may be a position where it is determined that the amount of change in sensor values is smaller than a predetermined value and the user 10 does not move for a predetermined amount of time on the basis of information from various sensors (for example, the positioning sensor 1503, the acceleration sensor 1504, and the gyro sensor 1505). In addition, in a case where the user 10 moves out of the control area range 206 without facing the direction of the video virtual object 205 for a predetermined period of time, the mutual disposition information processing unit 1523 performs a process which will be described below. That is, the mutual disposition information processing unit 1523 records the stay position where the user 10 stayed before leaving the control area range 206 and the direction from the stay position to the video virtual object 205.

Here, the direction from the stay position to the video virtual object 205 can be acquired appropriately. As an example, the orientation of the HMD 200 displaying the video virtual object 205 before the stop may be detected by the acceleration sensor 1504 or the gyro sensor 1505, and the detected orientation of the HMD 200 may be recorded as the direction from the stay position to the video virtual object 205. In addition, the direction of the virtual object or the like that is displayed to be superimposed may also be considered. As described above, the mutual disposition information processing unit 1523 records the mutual disposition information using the information related to the position of the user 10 or the line of sight of the user 10 with respect to the video virtual object 205 which was acquired and recorded before the pause of the video virtual object 205. That is, the mutual disposition information processing unit 1523 selects and acquires the viewing position and direction of the user 10 with respect to the video virtual object 205 before the pause from the information and records the viewing position and direction as the mutual disposition information. In addition, the mutual disposition information may be recorded as information of a position and direction having a predetermined range.

The predetermined gaze range processing unit 1524 selects the predetermined gaze range 233 having, as its center, the gaze location 232 of the user before the stop which has been specified by the left eye gaze sensor 201 and the right eye gaze sensor 202, generates predetermined gaze range information, and records the predetermined gaze range information in the memory 1530. For example, in a case where the position of the line of sight of the user 10 with respect to the video virtual object 205 does not move for a predetermined period of time, the predetermined gaze range processing unit 1524 specifies a location including the position of the line of sight that does not move as the gaze location 232. Alternatively, in a case where the amount of movement of the position of the line of sight of the user 10 with respect to the video virtual object 205 for a predetermined period of time is less than a predetermined threshold value, the predetermined gaze range processing unit 1524 specifies a location including the position where the amount of movement of the line of sight is less than the predetermined threshold value as the gaze location 232.

The suitable viewing disposition processing unit 1525 selects a suitable viewing position and direction of the video virtual object as suitable viewing disposition information and records the selected suitable viewing disposition information in the memory 1530. Examples of the suitable viewing disposition information include the position and gaze point of the user before the pause. In addition, examples of the suitable viewing disposition information include a suitable viewing position and direction for a view of a virtual object or the like that the user was gazing at in the video scene of the paused video virtual object. Further, examples of the suitable viewing disposition information include a suitable viewing position and direction for a specific virtual object that the user was gazing at in the video scene of paused the video virtual object or for a specific virtual object designated in advance by the user. Here, the gaze point, the virtual object that the user gazes at, or the like can be acquired on the basis of, for example, the left eye gaze sensor 201 and the right eye gaze sensor 202. The direction to a specific virtual object may be estimated by tracking the specific virtual object. The viewing position of the user is a position where the user can suitably view a target gaze point or the like and may be estimated on the basis of, for example, the position of each virtual object.

The playback position candidate processing unit 1526 selects candidates for the video playback position where the video virtual object is rewound and played back and records the candidates in the memory 1530. The candidates for the video playback position may be selected on the basis of information such as the length of the gaze time of the user 10, the frequency of the gaze, and a highlight scene (a scene that has the largest total number of views and includes information related to the viewing of other viewers or the like). In addition, the candidates for the video playback position may be selected on the basis of information such as the relationship between the video virtual object and the position of the user or the line of sight (viewing position and direction) of the user at the playback position candidate. Further, the candidates may be selected on the basis of content of the video virtual object (for example, information related to a highlight tag indicating a highlight added to the video virtual object or information related to the motion of an object of interest in the highlight) in addition to this viewing situation.

The surrounding situation processing unit 1527 records an image within the control area range, which has been captured by the camera 203 or displayed on the display processing device 1508, as the disposition location surrounding information 1539 in the memory 1530. Then, the surrounding situation processing unit 1527 determines whether or not a specific viewing location, such as a chair, or another viewer is present around the video virtual object (within the control area range) on the basis of the recorded information. In addition, control may be performed such that the object to be determined to be the specific viewing location, such as the chair, or another viewer is applied to not only a real object or a person but also a virtual object other than the video virtual object.

The disposition possibility processing unit 1528 analyzes the measurement result of the distance by the distance measurement sensor 1503 and the image captured by the camera 203 or displayed on the display processing device 1508. Then, the disposition possibility processing unit 1528 discerns the distance from the user 10 to the real object or another virtual object, the size of the real object or another virtual object, whether a horizontal surface is present or absent, the type of the real object or another virtual object (for example, a desk or a table), and the like and determines whether the video virtual object can be displaced.

With the above configuration, the HMD 200 performs the following operation as a basic operation. When the user is a predetermined distance away from the stereoscopic video virtual object 205 disposed in the three-dimensional space by the virtual object processing unit 1521, the HMD 200 pauses the motion of the video virtual object using the playback control processing unit 1522. In addition, the mutual disposition information processing unit 1523 acquires the mutual position and direction relationship between the video virtual object and the user or the line of sight of the user before the pause and records the mutual position and direction relationship as the mutual disposition information. After the pause, the user approaches within the predetermined distance from the video virtual object. At this time, the playback control processing unit 1522 controls the playback operation of the video virtual object on the basis of the recorded mutual disposition information, information related to the position of the user or the direction of the line of sight of the user after the user approaches within the predetermined distance, information related to the playback position candidates of the video virtual object 205, and the like. Examples of the control of the playback operation include playing back the video virtual object without any change, rotating the video virtual object and playing back the video virtual object, and rewinding the video virtual object by a predetermined amount of time and playing back the video virtual object.

Further, in the HMD 200, the predetermined gaze range processing unit 1524 selects a predetermined gaze range that has, as its center, the gaze location of the user in the state before the pause, generates the predetermined gaze range as the predetermined gaze range information, and records the predetermined gaze range. In a case where it is determined that the gaze target of the user has entered the predetermined gaze range indicated by the predetermined gaze range information after the pause, the playback operation of the video virtual object is resumed.

In addition, in the HMD 200, when the motion of the video virtual object is stopped, the suitable viewing disposition processing unit 1525 selects a suitable viewing position and direction of the video virtual object as the suitable viewing disposition information and notifies the user of the selected suitable viewing disposition information. Examples of the suitable viewing disposition information include the position and gaze point of the user before the pause and a suitable viewing position and direction for a view of a virtual object or the like that the user was gazing at in the video scene of the paused video virtual object. Further, examples of the suitable viewing disposition information include a suitable viewing position and direction for a specific virtual object that the user was gazing at in the video scene of the paused video virtual object or for a specific virtual object designated in advance.

Furthermore, in the HMD 200, the playback position candidate processing unit 1526 records candidates for the video playback position where the video virtual object is rewound and played back or the viewing position and direction at the video playback position. The playback position candidates are selected on the basis of gaze time information, such as the length of the gaze time of the user 10 at the video virtual object or the frequency of the gaze, a highlight scene (a scene that has the largest total number of views and includes information related to the viewing of other viewers or the like), information related to each viewing position and direction, and the like and then recorded. That is, the playback position candidates are selected on the basis of the viewing situation of the video virtual object and the content of the video virtual object (for example, information related to a highlight tag indicating a highlight added to the video virtual object or information related to the motion of an object of interest in the highlight or the like) and then recorded. The playback operation of the video virtual object is resumed from the video playback position selected by the user among the selected and recorded playback position candidates.

Furthermore, the user moves a predetermined distance away from the stereoscopic video virtual object 205, such as a soccer game video, disposed in the three-dimensional space by the virtual object processing unit 1521. Then, the playback control processing unit 1522 pauses the motion of the video virtual object, and the mutual disposition information processing unit 1523 acquires the mutual position and direction relationship between the video virtual object and the position and the line of sight of the user before the pause as the mutual disposition information and records the mutual disposition information. Then, in a case where the user is a predetermined distance away from the video virtual object for a predetermined period of time, the HMD 200 performs the following process. That is, the virtual object processing unit 1521 fixedly disposes the position and direction of the video virtual object in the local coordinate system of the HMD on the basis of the mutual disposition information recorded by the mutual disposition information processing unit 1523 so as to follow the movement of the HMD. In addition, the playback control processing unit 1522 controls the playback and stop operations of the video virtual object.

Further, in a case where the size of the video virtual object is larger than a predetermined threshold value when the virtual object processing unit 1521 fixedly disposes the video virtual object in the local coordinate system of the HMD, the HMD 200 performs the following process. That is, the HMD 200 reduces the video virtual object or extracts a region of a predetermined range including the gaze location of the video virtual object recorded by the predetermined gaze range processing unit 1524 and fixedly disposes the reduced video virtual object or the extracted region in the local coordinate system of the HMD.

Furthermore, in a case where the surrounding situation processing unit 1527 determines that a specific viewing location or another viewer is present around the disposed video virtual object, the HMD 200 performs the following process. That is, the HMD 200 performs control such that the virtual object processing unit 1521 does not fixedly dispose the video virtual object in the local coordinate system of the HMD or such that the video virtual object is duplicated and fixedly disposed in the local coordinate system of the HMD.

Further, the user moves a predetermined distance away from the stereoscopic video virtual object 205, such as a soccer game video, disposed in the three-dimensional space by the virtual object processing unit 1521. Then, the playback control processing unit 1522 pauses the motion of the video virtual object, and the mutual disposition information processing unit 1523 acquires the mutual position and direction relationship between the video virtual object and the position of the user or the line of sight of the user before the pause as the mutual disposition information and records the mutual disposition information. Then, in a case where the disposition possibility processing unit 1528 determines that the video virtual object can be newly disposed when the user approaches another possible disposition location, the HMD 200 performs the following process. That is, the virtual object processing unit 1521 performs control to newly fixedly disposes the video virtual object in a state in which the mutual position and direction relationship between the video virtual object and the position of the user or the line of sight of the user at the time of the pause is maintained and to resume the playback operation of the video virtual object.

Therefore, it is possible to achieve an information processing apparatus that enables the user to simply and conveniently stop or resume viewing by an operation at an appropriate timing corresponding to the situation of the user or the disposition situation of the stereoscopic video virtual object, without requiring a specific operation of the user, when the user views the stereoscopic video virtual object disposed at a specific location. For example, in a case where any emergency occurs while the user wearing the HMD is viewing the video virtual object, the user can conveniently stop or resume the motion of the video virtual object at the appropriate time.

In addition, in the above description, the HMD has been described as a specific example of the information processing apparatus. However, it goes without saying that the present invention can be applied to all apparatus having similar functions and the same functions and effects can be obtained even in information processing apparatus, such as smartphones and smartwatches, other than the HMD.

Further, the present invention is not limited to the above-described embodiment and includes various modification examples. For example, the above-described embodiment has been described in detail to clearly explain the present invention, and the present invention is not necessarily limited to the embodiment having all the above-described configurations. In addition, it is possible to replace a portion of the configuration of one embodiment with a configuration of another example. Further, it is also possible to add the configuration of one embodiment to the configuration of another embodiment. Furthermore, it is possible to add, delete, or replace a portion of the configuration of each embodiment with other configurations.

Moreover, the numerical values, messages, and the like described in the specification and the drawings are only examples, and the effects of the present invention will not be impaired even when different numerical values and messages are used.

In addition, some or all of the above-mentioned configurations, functions, processing units, processing means, and the like may be designed as, for example, integrated circuits to be implemented by hardware. Further, the above-described configurations, functions, and the like may be implemented by software. For example, the processor interprets a program for implementing the functions of the above-described configurations and executes the program to implement the functions. The processor includes transistors and other circuits and is regarded as circuitry or processing circuitry. Information of programs, tables, files, and the like for implementing each function may be stored in a memory, a recorder, such as a hard disk or a solid state drive (SSD), or a recording medium, such as an IC card, an SD card, or a DVD, or may be stored in a device on a communication network.

Further, the control lines and the information lines indicate configurations considered necessary for the explanation, and not all of the control lines and the information lines are necessarily illustrated in the product. In practice, almost all configurations can be considered to be interconnected.

The range and shape of the control area may be freely set by the user. In addition, a method in which the user appropriately selects the control area from a plurality of patterns registered in advance may be adopted. Information of the range of the control area determined by the user is stored in the memory 1530 and is used for the processes of the HMD 200.

### REFERENCE SIGNS LIST

10 User
200 Head mounted display (HMD)
201 Left eye gaze sensor
202 Right eye gaze sensor
203 Camera
204 Real object (desk)
205 Video virtual object
206 Control area range
208 Display screen
215 Positioning sensor
216 Geomagnetic sensor
1503 Distance measurement sensor
1504 Acceleration sensor
1505 Gyro sensor
1507 Operation input interface
1508 Display processing device
1520 Processor
1521 Virtual object processing unit
1522 Playback control processing unit
1523 Mutual disposition information processing unit
1524 Predetermined gaze range processing unit
1525 Suitable viewing disposition processing unit
1526 Playback position candidate processing unit
1527 Surrounding situation processing unit
1528 Disposition possibility processing unit
1530 Memory
1541 Vibration generation device
1542 Voice input device
1543 Voice output device
1544 Communication device
1545 Timer
1550 Bus

1. An information processing apparatus worn by a user, the information processing apparatus comprising:
a processor controlling playback of a stereoscopic video virtual object;
a positioning sensor detecting a position of the user;
a gaze sensor detecting a direction of a line of sight of the user; and
a memory,
wherein the processor
records, in the memory, user information including at least one of a disposition position where the played video virtual object is disposed, the position of the user detected by the positioning sensor, and the direction of the line of sight of the user detected by the gaze sensor,
performs control to stop the playback of the video virtual object when detecting that the user has moved out of a range that is a predetermined distance away from the disposition position using the positioning sensor, and
performs control to resume the playback of the video virtual object on the basis of the user information recorded in the memory and the position detected by the positioning sensor or the direction of the line of sight detected by the gaze sensor when the user enters the range after the playback of the video virtual object is stopped.

2. The information processing apparatus according to claim 1,
wherein, in a case where the user enters the range after the playback of the video virtual object is stopped, when the position detected by the positioning sensor and the direction of the line of sight detected by the gaze sensor correspond to the user information recorded in the memory, the processor resumes the playback of the video virtual object.

3. The information processing apparatus according to claim 1,
wherein, in a case where the user enters the range after the playback of the video virtual object is stopped, when the position detected by the positioning sensor or the direction of the line of sight detected by the gaze sensor is different from the user information recorded in the memory, the processor performs control to notify the user of the difference.

4. The information processing apparatus according to claim 1,
wherein the processor
records a range of the video virtual object in the direction of the line of sight as a gaze range in the memory in a case where an amount of change in the direction of the line of sight of the user detected by the gaze sensor is equal to or less than a threshold value for a predetermined period of time, and
resumes the playback of the video virtual object when the user enters the range after the playback of the video virtual object is stopped and the direction of the line of sight of the user enters the gaze range.

5. The information processing apparatus according to claim 1,
wherein the processor
records a position and direction suitable for viewing the video virtual object as suitable disposition information in the memory, and
notifies the user of the suitable disposition information recorded in the memory when the user enters the range after the playback of the video virtual object is stopped.

6. The information processing apparatus according to claim 1, further comprising:
a display displaying the video virtual object played back by the processor,
wherein, when the user enters the range after the playback of the video virtual object is stopped and the position detected by the positioning sensor or the direction of the line of sight detected by the gaze sensor is different from the user information recorded in the memory, the processor performs control to rotate the video virtual object and to display the video virtual object on the display.

7. The information processing apparatus according to claim 1, further comprising:
a display,
wherein the processor
performs control to display the video virtual object on the display to be superimposed on a real object, and
performs control to rotate the video virtual object according to a shape or size of the real object and to display the video virtual object on the display when the user enters the range after the playback of the video virtual object is stopped and the position detected by the positioning sensor or the direction of the line of sight detected by the gaze sensor is different from the user information recorded in the memory.

8. The information processing apparatus according to claim 1,
wherein, when the user enters the range after the playback of the video virtual object is stopped, the processor performs control to resume the playback of the video virtual object at a position that is a predetermined time before a position where the playback of the video virtual object was stopped.

9. The information processing apparatus according to claim 1,
wherein the processor
records a plurality of playback positions as a position where the video virtual object is played back in the memory,
notifies the user of the plurality of playback positions when the user enters the range after the playback of the video virtual object is stopped, and
performs control to resume the playback of the video virtual object from a playback position selected by the user.

10. The information processing apparatus according to claim 1,
wherein the processor
notifies the user whether or not to resume the playback of the video virtual object when the user does not enter the range even after a predetermined time has elapsed since the playback of the video virtual object was stopped, and
performs control to dispose the video virtual object, whose playback has been resumed, at a position different from the disposition position recorded in the memory when the user selects to resume the playback.

11. An information processing apparatus that has a function of generating a stereoscopic video virtual object and displaying the stereoscopic video virtual object and is worn by a user, the information processing apparatus comprising:
a processor; and
a storage,
wherein the processor
records mutual disposition information, which is a mutual position and direction relationship between the video virtual object and a position and a line of sight of the user, in the storage,
stops playback of the video virtual object when the user moves away from the video virtual object and a distance between the video virtual object and the user is equal to or greater than a predetermined distance,
disposes the video virtual object so as to follow a movement of the information processing apparatus in a state based on the mutual disposition information recorded in the storage after a predetermined time has elapsed since the stop; and
controls a playback operation of the disposed video virtual object.

12. The information processing apparatus according to claim 11,
wherein the processor
notifies the user whether or not to play back a motion of the disposed video virtual object, and
performs the playback operation of the disposed video virtual object when the user who has received the notification selects to play back the motion of the disposed video virtual object.

13. The information processing apparatus according to claim 11,
wherein, when discerning that a size of the video virtual object is larger than a predetermined threshold value, the processor reduces the size of the video virtual object and disposes the video virtual object.

14. The information processing apparatus according to claim 11,
wherein the processor
records a gaze location of the user on the video virtual object before the stop in the storage, and
disposes the video virtual object obtained by extracting a range of a predetermined region including the gaze location recorded in the storage when discerning that a size of the video virtual object is larger than a predetermined threshold value.

15. An information processing method in an apparatus that is worn by a user and is used, the information processing method comprising:
playing back a stereoscopic video virtual object;
disposing and displaying the played video virtual object to be superimposed on a real object;
recording user information including at least one of a disposition position where the played video virtual object is disposed, a position of the user, and a direction of a line of sight of the user;
stopping the playback of the video virtual object when it is detected that the user has moved out of a range that is a predetermined distance away from the disposition position; and
resuming the playback of the video virtual object on the basis of the recorded user information when the user enters the range after the playback of the video virtual object is stopped.
